(19) United States
(12) Patent Application Publication
(10) Pub. No.: US 2010/0076771 A1
(43) Pub. Date: Mar. 25, 2010

(54) VOICE SIGNAL PROCESSING APPARATUS AND VOICE SIGNAL PROCESSING METHOD

(75) Inventor: Fumio AMANO, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 12/560,805

(22) Filed: Sep. 16, 2009

(30) Foreign Application Priority Data
Sep. 25, 2008 (JP) 2008-246015

(51) Int. Cl. G10L 21/02

(52) U.S. Cl. 704/278; 704/E21.002

(57) ABSTRACT

A voice signal processing apparatus and method includes determining maximum amplitude values of a plurality of different voice frame signals obtained by giving different amounts of phase shift to frequency components of voice frame signals having a predetermined length which are divided from a digital voice signal, and selecting a voice frame signal whose maximum amplitude value is the minimum from among the amplitude values of the plurality of different voice frame signals.

### CROSS-REFERENCE TO RELATED APPLICATIONS

This application is based upon and claims the benefit of priority of the prior Japanese Patent Application No. 2008-246015, filed on Sep. 25, 2008, the entire contents of which are incorporated herein by reference.

### BACKGROUND

1. Field

The embodiments relate to a voice signal processing apparatus and a voice signal processing method of processing an input or received voice signal.

2. Description of the Related Art

For example, in a case where a user is not likely to hear a voice output from a speaker of a mobile phone due to ambient noise during a phone call. Therefore, some techniques are considered which enable the user to easily hear the output voice in this situation.

For example, a technique is considered which analyzes the spectrum of an output voice signal and emphasizes a specific important frequency component, for example, a frequency component of a formant frequency. In addition, a technique is considered which calculates a S/N (signal-to-noise ratio) ratio between the output voice and background noise and amplifies a level of a voice signal such that the S/N ratio is equal to or greater than a predetermined value. Further, a compander circuit has been proposed which adaptively controls the gain of a voice signal according to a level of the original signal of an output voice signal. The compander circuit amplifies a low-level original signal at a high gain and amplifies a high-level original signal at a low gain such that the amplified signal does not exceed the maximum allowable output level of an amplifying circuit.

Japanese Laid-Open Patent Publication No. 2002-223268 discusses a voice control device including a transmitter, a receiver, a frequency analysis unit that analyzes the frequency characteristics of noise input from the transmitter, and a frequency characteristic converting unit that converts the frequency characteristics of the received voice output to the receiver on the basis of the analysis result of the frequency analysis unit. The frequency analysis unit detects a high noise frequency band having a large amount of ambient noise and analyzes it, and based on the analysis result, the frequency characteristic converting unit emphasizes a received voice band other than the high noise frequency band.

Japanese Laid-Open Patent Publication No. 2002-223268 discusses a mobile phone that includes a transmitter and a receiver and can perform voice communication using wireless signals. The mobile phone includes a frequency analysis unit that analyzes the frequency characteristics of ambient noise input from the transmitter and a frequency characteristic converting unit that converts the frequency characteristics of the received voice composed of the wireless signals on the basis of the analysis result of the frequency analysis unit during voice communication.

The method according to the related art has restrictions in improving the hearing of the user when the level of ambient noise is excessively high. For example, in the method according to the related art that calculates the S/N ratio between an output voice and background noise and amplifies the level of the voice signal such that a desired S/N ratio is obtained, when the amplified output voice level is greater than the maximum allowable value of the amplifying circuit, clipping distortion occurs in the waveform of the voice signal, and voice quality deteriorates. In the method using the compander circuit, distortion also occurs in the waveform of the voice signal, and voice quality deteriorates.

### SUMMARY

According to an aspect of the invention, a voice signal processing apparatus and method include determining maximum amplitude values of a plurality of different voice frame signals obtained by giving different amounts of phase shift to frequency components of voice frame signals having a predetermined length which are divided from a digital voice signal, and selecting a voice frame signal whose maximum amplitude value is a minimum among the amplitude values of the plurality of different voice frame signals

The object and advantages of the invention will be realized and attained by means of the elements and combinations particularly pointed out in the claims.

It is to be understood that both the foregoing general description and the following detailed description are exemplary and explanatory and are not restrictive of the invention.

Additional aspects and/or advantages will be set forth in part in the description which follows and, in part, will be apparent from the description, or may be learned by practice of the invention.

### BRIEF DESCRIPTION OF THE DRAWINGS

These and/or other aspects and advantages will become apparent and more readily appreciated from the following description of the embodiments, taken in conjunction with the accompanying drawings of which:

FIG. 1 is a diagram illustrating a structure of a voice processing apparatus according to an embodiment of the invention;

FIG. 2 is a diagram illustrating an example of a structure of a phase selecting unit illustrated in FIG. 1;

FIG. 3 is a flowchart illustrating a voice processing method according to an embodiment of the invention;

FIG. 4 is a flowchart illustrating an example of a process of reducing a maximum value of a voice signal;

FIGS. 5A and 5B are diagrams illustrating waveforms of a voice frame signal before and after a process of reducing the maximum value of the voice signal;

FIG. 6 is a diagram illustrating an example of a gain determining process performed by a gain determining unit illustrated in FIG. 1;

FIG. 7 is a flowchart illustrating an example of a process of connecting voice frame signals performed by a frame connecting unit illustrated in FIG. 1;

FIGS. 8A and 8B are diagrams illustrating examples of a process of connecting voice frame signals performed by the frame connecting unit illustrated in FIG. 1;

FIG. 9 is a diagram illustrating a structure of a voice processing apparatus according to an embodiment of the invention;

FIG. 10 is a diagram illustrating an example of a structure of a phase selecting unit illustrated in FIG. 9;

FIG. 11 is a flowchart illustrating an example of a process of reducing a maximum value of a voice signal;

FIG. 12 is a flowchart illustrating a process of determining whether a phase shift satisfies predetermined selection condition(s);

FIGS. 13A, 13B, 13C and 13D are diagrams illustrating a determining process shown in FIG. 12;

FIG. 14 is a flowchart illustrating an example of a gain determining process performed by a gain determining unit illustrated in FIG. 9;

FIGS. 15A, 15B and FIG. 15C are diagrams illustrating an example of a gain determining process performed by the gain determining unit illustrated in FIG. 9;

FIG. 16 is a flowchart illustrating an example of the gain determining process performed by the gain determining unit illustrated in FIG. 9;

FIG. 17 is a diagram illustrating another example of the gain determining process performed by the gain determining unit illustrated in FIG. 9;

FIG. 18 is a diagram illustrating a structure of a voice processing apparatus according to an embodiment of the invention;

FIG. 19 is a diagram illustrating an example of a structure of a phase selecting unit illustrated in FIG. 18;

FIG. 20 is a flowchart illustrating an example of a process of reducing a maximum value of a voice signal;

FIG. 21 is a diagram illustrating a structure of a voice processing apparatus according to an embodiment of the invention;

FIG. 22 is a flowchart illustrating an example of a process of reducing a maximum value of a voice signal;

FIG. 23 is a diagram illustrating a structure of a voice processing apparatus according to an embodiment of the invention;

FIG. 24 is a flowchart illustrating an example of a process of reducing a maximum value of a voice signal;

FIG. 25 is a diagram illustrating a structure of a voice processing apparatus according to an embodiment of the invention;

FIG. 26 is a characteristic diagram illustrating frequency-phase characteristics of an all-pass filter;

FIG. 27A is a diagram illustrating an example of a structure of the all-pass filter;

FIG. 27B is a diagram illustrating another example of the structure of the all-pass filter;

FIG. 27C is a diagram illustrating an example of the structure of the all-pass filter;

FIG. 27D is a diagram illustrating an example of the structure of the all-pass filter;

FIG. 28A is a diagram illustrating an example of the structure of the all-pass filter;

FIG. 28B is a diagram illustrating another example of the structure of the all-pass filter;

FIG. 29 is a flowchart illustrating another example of a process of reducing the maximum value of a voice signal; and

FIG. 30 is a diagram illustrating a relationship between combination of the phase shift amounts and the phase shift amounts given to the frequencies fi (i=1˜K).

### DETAILED DESCRIPTION OF EMBODIMENTS

Reference will now be made in detail to the embodiments, examples of which are illustrated in the accompanying drawings, wherein like reference numerals refer to the like elements throughout. The embodiments are described below to explain the present invention by referring to the figures.

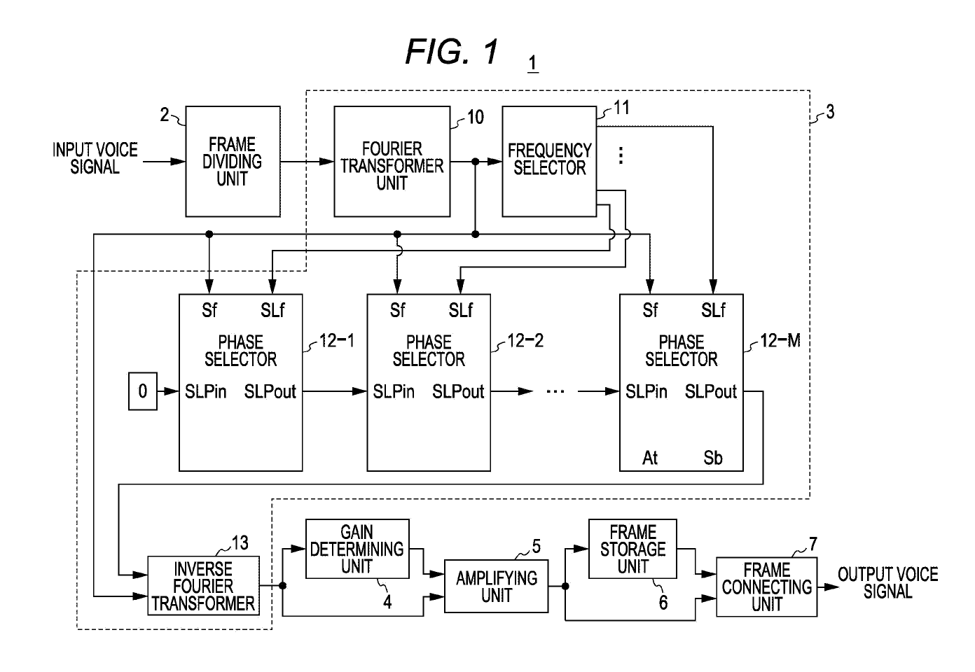

Hereinafter, embodiments of the invention will be described with reference to the accompanying drawings. FIG. 1 is a diagram illustrating a structure of a voice processing apparatus according to an embodiment of the invention. A voice processing apparatus 1 includes a frame dividing unit 2, a maximum value reducing unit 3, a gain determining unit 4, an amplifying unit 5, a frame storage unit 6, and a frame connecting unit 7.

The frame dividing unit 2 divides an input digital voice signal into voice frame signals having a predetermined length.

The maximum value reducing unit 3 shifts a phase of the frequency component of each of the voice frame signals sequentially output from the frame dividing unit 2 to reduce a maximum amplitude value of each voice frame signal.

The gain determining unit 4 determines the gain of the voice frame signal on the basis of the maximum amplitude value of the voice frame signal whose maximum amplitude value is reduced by the maximum value reducing unit 3. The amplifying unit 5 amplifies the voice frame signal whose maximum amplitude value is reduced by the maximum value reducing unit 3 at the gain determined by the gain determining unit 4.

The frame storage unit 6 stores at least R samples from the last sample of the voice frame signal amplified by the amplifying unit 5 until the next voice frame signal is output from the amplifying unit 5. The frame connecting unit 7 connects (associates) the voice frame signal output from the amplifying unit 5 and a voice frame signal in the previous frame of the voice frame signal. The frame connecting process of the frame connecting unit 7 is described in detail below.

The maximum value reducing unit 3 includes a Fourier transformer unit 10, a frequency selector 11, M phase selecting units (phase selectors) 12-1, 12-2, . . . , 12-M connected in series with each other, and an inverse Fourier transformer 13. The Fourier transformer 10 performs Fourier transform on the voice frame signals sequentially supplied from the frame dividing unit 2 to generate frequency domain signals indicating the frequency components of the voice frame signals. The frequency domain signal is output to the frequency selector 11, the phase selecting units 12-1 to 12-M, and the inverse Fourier transformer 13. Each of the phase selecting units 12-1 to 12-M receives the frequency domain signal as an input Sf.

The frequency selector 11 outputs a signal indicating a frequency having the highest spectral intensity, a signal indicating a frequency having the second highest spectral intensity, . . . , a signal indicating a frequency having the M-th highest spectral intensity, on the basis of the spectral intensity of each frequency component output from the Fourier transformer 10. The signal indicating the frequency having the highest spectral intensity, the signal indicating the frequency having the second highest spectral intensity, . . . , the signal indicating the frequency having the M-th highest spectral intensity are input to the phase selecting units 12-1, 12-2, . . . , 12-M as inputs SLf, respectively.

When a plurality of different amounts of phase shift are given to the frequency component of a frequency f designated by the input SLf among the frequency components given as the inputs Sf to perform inverse Fourier transform on a time domain signal, each of the phase selecting units 12-1 to 12-M selects a phase shift amount that allows the maximum amplitude value of the voice frame signal to be the minimum as a phase shift amount given to the frequency component of the frequency f.

Each of the phase selecting units 12-1 to 12-M outputs a phase selection signal indicating the selected phase shift amount as an output SLPout. The phase selection signals output from the previous phase selecting units 12-1 to 12-(M−1) are input to the next phase selecting units 12-2 to 12-M, respectively, as inputs SLPin.

When receiving the phase selection signal from the previous phase selecting unit 12-i that has selected the phase shift amount given to the frequency component of a frequency fi, the next phase selecting unit 12-(i+1) (i=1 to M−1) selects a phase shift amount to be given (assigned) to the frequency component of a frequency f(i+1) designated by the input SLf. The phase selecting unit 12-(i+1) (i=1 to M−1) receiving the phase selection signal from the previous phase selecting unit 12-i that has selected the phase shift amount given to the frequency component of the frequency fi adds the selected phase shift amount to the phase selection signal input from the previous phase selecting unit 12-i and outputs the signal to the next phase selecting unit 12-(i+2).

When selecting a phase shift amount to be given (assigned) to the frequency component of the frequency fi (i=2 to M) designated by the input SLf, each phase selecting unit 12-i gives each phase shift amount designated by the phase selection signal input from the previous phase selecting unit 12-(i−1) to frequency components other than the frequency fi.

Each phase selecting unit 12-i (i=2 to M) gives the phase shift amount, designated by the phase selection signal input from the previous phase selecting unit 12-(i−1), to frequency components other than the frequency fi. When a plurality of different phase shift amounts Δθ1 to ΔθL are given to the frequency components of the frequencies fi to perform inverse Fourier transform on the time domain signal, each phase selecting unit 12-(i−1) (i=2 to M) selects a phase shift amount that allows the maximum amplitude value of the voice frame signal to be the minimum from the phase shift amounts Δθ1 to ΔθL. The phase selection signal that does not designate the phase shift amounts for all the frequency components is input to the input SPLin of the first phase selecting unit 12-1.

A composite signal of the phase selection signals indicating the phase shift amounts given to the frequency having the highest spectral intensity, the frequency having the second highest spectral intensity, . . . , the frequency having the M-th highest spectral intensity, which are respectively selected by the phase selecting units 12-1 to 12-M, is output from the output SPLout of the last phase selecting unit 12-M to the inverse Fourier transformer 13.

The inverse Fourier transformer 13 gives each phase shift amount, designated by the phase selection signal output from the phase selecting unit 12-M, to each frequency component of the frequency domain signal output from the Fourier transformer 10 to perform inverse Fourier transform on the frequency domain signal, thereby generating a voice frame signal. The inverse Fourier transformer 13 outputs the voice frame signal to the gain determining unit 4 and the amplifying unit 5.

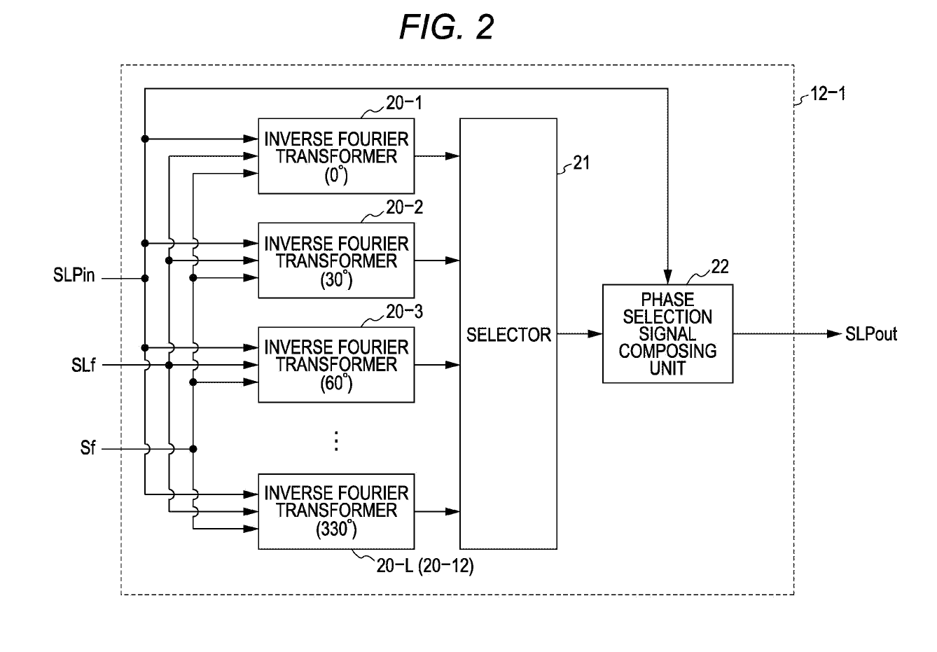

FIG. 2 is a diagram illustrating an example of a structure of the phase selecting unit illustrated in FIG. 1. The other phase selecting units 12-2 to 12-M have the same structure as the phase selecting unit 12-1. The phase selecting unit 12-1 includes L inverse Fourier transformers 20-1 to 20-L, a selector 21, and a phase selection signal composing unit 22.

The L inverse Fourier transformers 20-j (j=1, 2, . . . , L) give a phase shift of (360/L×(j−1)) degrees to the frequency component of the frequency f designated by the input SLf, among the frequency components of the frequency domain signal, which is the input Sf. Each of the L inverse Fourier transformers 20-j (j=1, 2, . . . , L) gives a phase shift amount designated by the phase selection signal, which is the input SLPin, to the other frequency components to perform inverse Fourier transform on the frequency domain signal, thereby generating the voice frame signal.

In this embodiment, a natural number L is 12. The phase selecting unit 12-1 includes twelve inverse Fourier transformers 20-1 to 20-12. The inverse Fourier transformer 20-1 gives a phase shift of 0 degree to the frequency component of the frequency f designated by the input SLf. The inverse Fourier transformer 20-2 gives a phase shift of 30 degrees to the frequency component of the frequency f. The inverse Fourier transformer 20-3 gives a phase shift of 60 degrees to the frequency component of the frequency f. The inverse Fourier transformer 20-12 gives a phase shift of 330 degrees to the frequency component of the frequency f. The natural number L may be other values equal to or greater than 2.

The selector 21 selects the voice frame signal whose maximum amplitude value is the minimum among the voice frame signals generated by the inverse Fourier transformers 20-1 to 20-12. The selector 21 outputs a phase selection signal indicating the phase shift amount given to the frequency component of the frequency f of the selected voice frame signal.

The phase selection signal composing unit 22 inserts the phase selection signal output from the selector 21, as a phase shift amount to be given to the frequency component of the frequency f, into the phase selection signal, which is the input SLPin, to compose the phase selection signal input as the input SLPin and the phase selection signal output from the selector 21. The phase selection signal composing unit 22 outputs the composed phase selection signal as the output SLPout.

A maximum amplitude value determining unit includes for example, the inverse Fourier transformers 20-1 to 20-12 and the selector 21. A selecting unit includes for example, the selector 21.

A frequency component determining unit includes for example, the Fourier transformer 10. A combination determining unit includes for example, the inverse Fourier transformers 20-1 to 20-12 in each of the phase selecting units 12-1 to 12-M.

A candidate generating unit includes for example, the inverse Fourier transformers 20-1 to 20-12. Candidate signals include for example, the voice frame signals output from the inverse Fourier transformers 20-1 to 20-12. A candidate selecting unit includes for example, the selector 21.

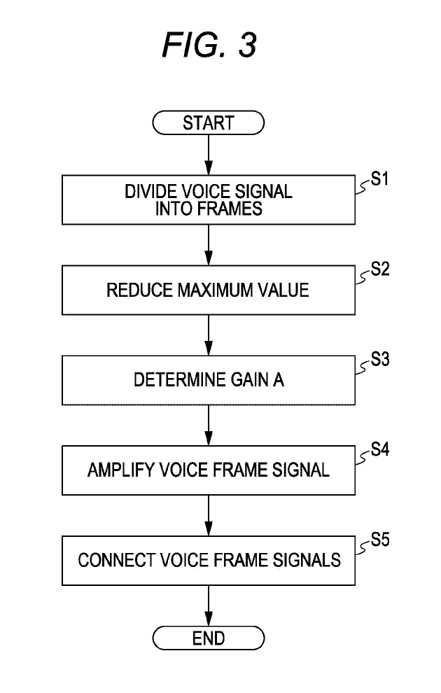

FIG. 3 is a flowchart illustrating a voice processing method according to an embodiment of the invention. In Operation S1, the frame dividing unit 2 illustrated in FIG. 1, for example, divides an input digital voice signal into voice frame signals having a predetermined length. In Operation S2, the maximum value reducing unit 3, for example, reduces the maximum amplitude value of the voice frame signal.

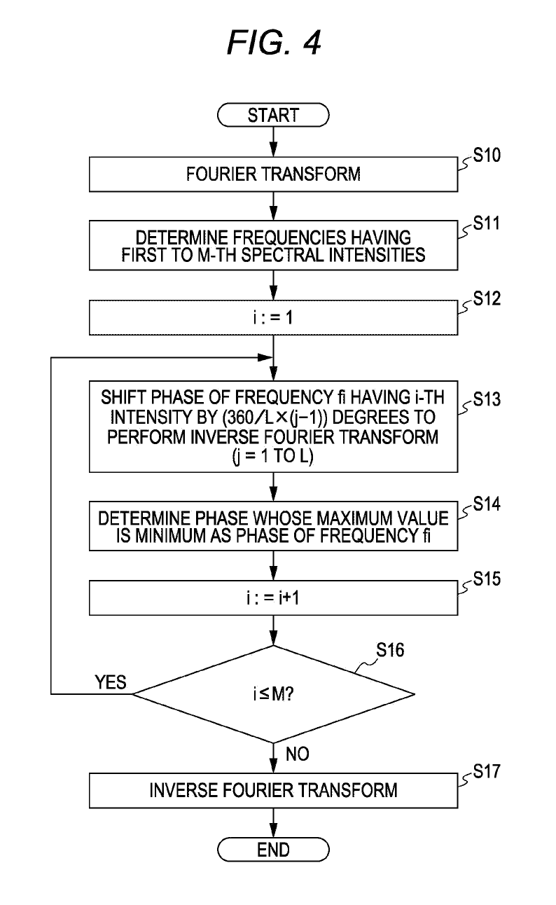

FIG. 4 is a flowchart illustrating an example of a process of reducing the maximum value of the voice signal. In Operation S10, the Fourier transformer 10 illustrated in FIG. 1 performs Fourier transform on the voice frame signal to generate a frequency domain signal indicating each frequency component of the voice frame signal.

In Operation S11, the frequency selector 11 determines the frequencies fi (i=1 to M) having the first to M-th highest spectral intensities on the basis of the spectral intensity of each frequency component indicated by the frequency domain signal input from the Fourier transformer 10. The frequency selector 11 inputs the signals indicating the frequencies fi to fM having the first to M-th highest spectral intensities as the inputs SLf to the phase selecting units 12-1, 12-2, and 12-M, respectively.

In Operation S12, the value of an index variable i referring to the phase selecting unit 12-i (i=1 to M) is initialized to “1”.

In Operation S13, an i-th phase selecting unit 12-i receives a signal indicating a frequency fi having the i-th highest spectral intensity as the input SLf.

The inverse Fourier transformer 20-j (j=1 to 12) of the phase selecting unit 12-i gives each phase shift amount designated by the phase selection signal input from the previous phase selecting unit 12-(i−1) to the frequency components other than the frequency fi designated by the input SLf, among the frequency components output from Fourier transformer 10, and gives a phase shift of (360/Lx(j−1)) degrees to the frequency components of the frequency fi to perform inverse Fourier transform on the time domain signal.

In Operation S14, the selector 21 of the phase selecting unit 12-i selects the voice frame signal whose maximum amplitude value is the minimum among the voice frame signals generated by the inverse Fourier transformers 20-1 to 20-12. The selector 21 outputs a phase selection signal indicating the phase shift amount to be given to the frequency component fi of the voice frame signal selected from the voice frame signals generated by the inverse Fourier transformers 20-1 to 20-12. The phase selection signal composing unit 22 composes the phase selection signal input as the input SLPin and the phase selection signal output from the selector 21. The phase selection signal composing unit 22 outputs the composed phase selection signal as the output SLPout.

In Operation S15, the value of the index variable i is increased by one. In Operation S16, when the value of the index variable i is equal to or less than “M”, that is, when there is a phase selecting unit that does not complete the phase selecting process, the process returns to Operation S13, and Operations S13 to S16 are repeatedly performed.

If it is determined in Operation S16 that the value of the index variable i is greater than “M”, the process proceeds to Operation S17. In Operation S17, the inverse Fourier transformer 13 illustrated in FIG. 1 gives the phase shift amount designated by the phase selection signal received from the last phase selecting unit 12-M to each of the frequency components received from the Fourier transformer 10 to perform inverse Fourier transform on the frequency domain signal, thereby generating the voice frame signal.

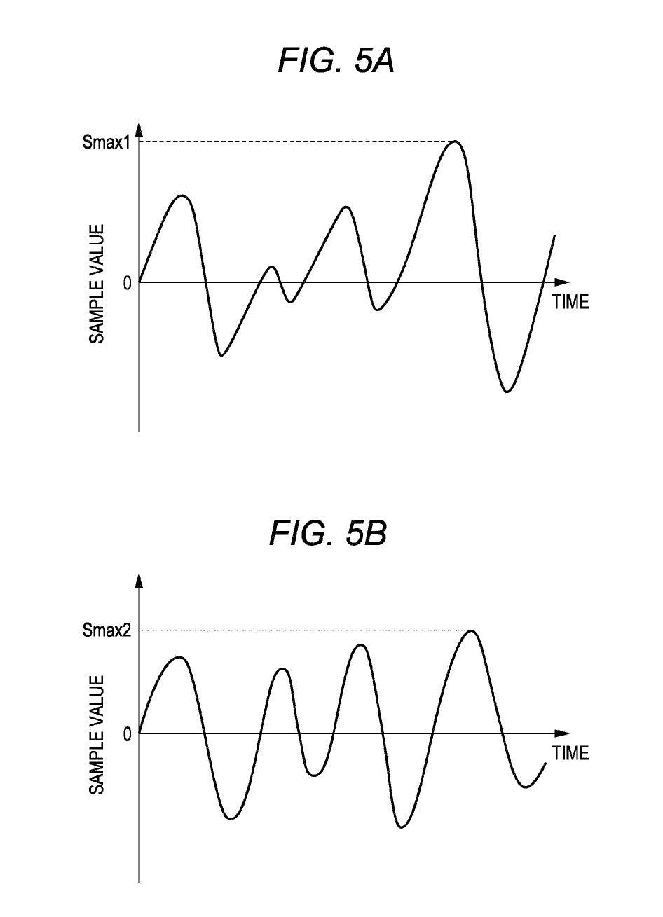

FIGS. 5A and 5B are diagrams illustrating waveforms of a voice frame signal before and after the process of reducing the maximum value of the voice signal. Since the voice frame signals are generated by the inverse Fourier transformers 20-1 to 20-12 of each of the phase selecting units 12-1 to 12-M in the maximum value reducing unit 3 by shifting the phases of the frequency components of the original voice frame signals, the waveforms of the generated voice frame signals are different from those of the original voice frame signals.

The selector 21 of each of the phase selecting units 12-1 to 12-M selects the voice frame signal whose maximum amplitude value is the minimum among the voice frame signals having different waveforms. Therefore, the maximum amplitude value of the voice frame signal selected by the selector 21 is equal to or less than the maximum amplitude value of the original voice frame. For example, when the maximum amplitude value of the original voice frame signal is generated by the overlap between some frequency components having relatively large amplitudes among a plurality of frequency components, it is possible to reduce the maximum amplitude value by giving different amounts of phase shift to the frequency components.

Therefore, the voice frame signal whose maximum amplitude value is reduced by the maximum value reducing unit 3, that is, the maximum amplitude value Smax2 of the voice frame signal illustrated in FIG. 5B is smaller than the maximum amplitude value Smax1 of the original voice frame signal illustrated in FIG. 5A.

Even when there is a little variation in the phase characteristics of each frequency component, the human ear cannot sense the variation. Therefore, the maximum value reducing unit 3 can reduce the maximum amplitude value of the voice frame signal without deteriorating the quality of a voice heard by the human ear.

In Operation S3 illustrated in FIG. 3, the gain determining unit 4 determines the gain A of the voice frame signal on the basis of the maximum amplitude value of the voice frame signal output from the maximum value reducing unit 3. In Operation S4, the amplifying unit 5 amplifies the voice frame signal output from the maximum value reducing unit 3 at the gain A determined by the gain determining unit 4.

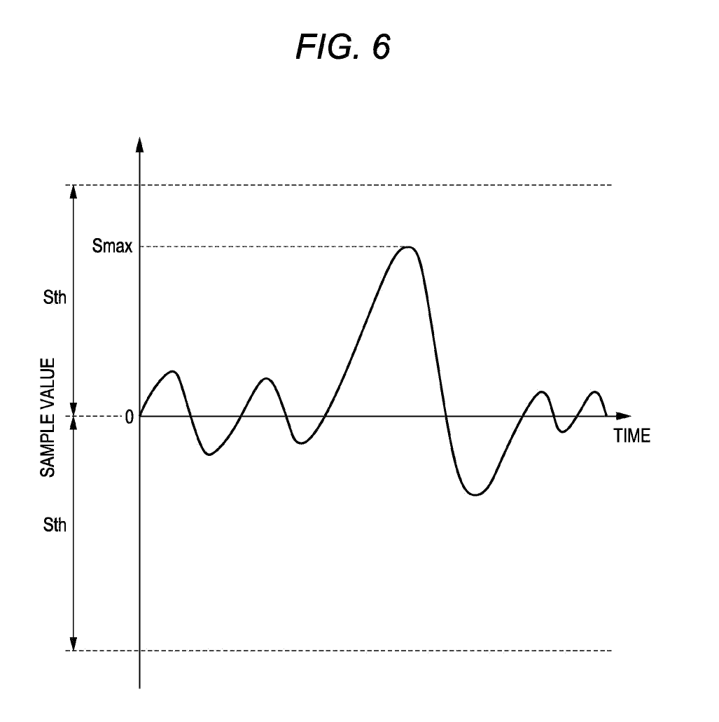

FIG. 6 is a diagram illustrating an example of a gain determining process performed by the gain determining unit illustrated in FIG. 1. FIG. 6 illustrates the waveform of the voice frame signal output from the maximum value reducing unit 3. For example, the gain determining unit 4 may determine, as the gain A, a maximum gain at which the voice frame signal is amplified by the amplifying unit 5 not to be more than the maximum allowable output amplitude value Sth of the amplifying unit 5.

For example, when the maximum amplitude value of the voice frame signal output from the maximum value reducing unit 3 is Smax, the gain determining unit 4 determines a value Sth/Smax as the gain A. When the gain determining unit 4 determines the gain A in this way, the voice frame signal is amplified by the amplifying unit 5 without any clipping and any other distortion.

In this manner, the gain determining unit 4 and the amplifying unit 5 can amplify the voice frame signal at a higher gain as the maximum amplitude value before amplification becomes smaller. In this embodiment, the maximum value reducing unit 3 reduces the maximum amplitude value of the voice frame signal. Therefore, it is possible to amplify a voice signal at a high gain, and it is possible to improve the hearing of the user in a large background noise environment without deteriorating the quality of a voice heard by the human ear.

In Operation S5 (FIG. 3), the frame connecting unit 7 connects (associates or links) the voice frame signal output from the amplifying unit 5 and a voice frame signal in the previous frame of the voice frame signal.

Before the maximum value reducing unit 3 performs voice signal processing, the last sample value of a first frame and the first sample value of a second frame in two continuous frames are substantially equal to each other.

However, when the maximum value reducing unit 3 shifts the phase of each frequency component, the waveform of each voice frame signal is changed. As a result, of two continuous frames, a large difference is likely to occur between the last sample value of the first frame and the first sample value of the second frame.

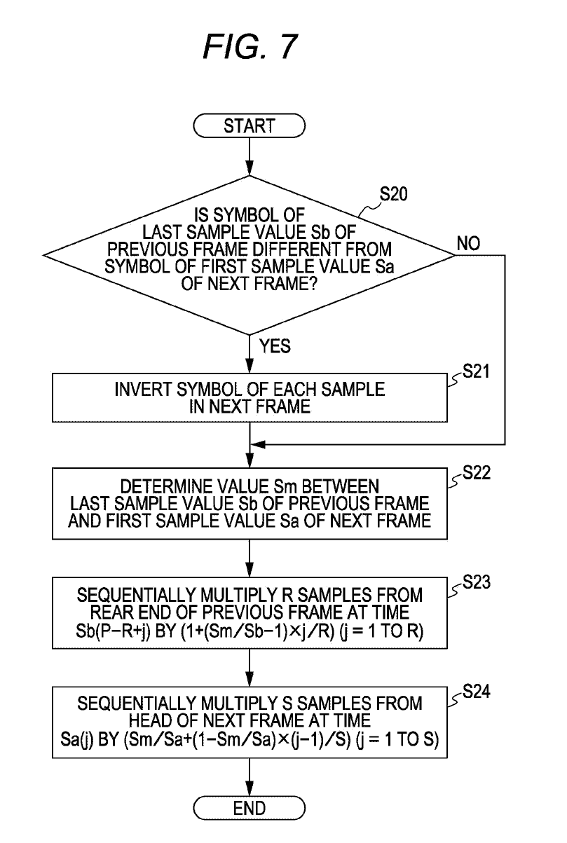

The frame connecting unit 7 sets a target value between the last sample value Sb of the previous frame and the first sample value Sa of the next frame, and makes R samples from the rear end of the first frame and S samples from the head of the next frame close to the target value. In this way, the frame connecting unit 7 smoothly connects two frames. FIG. 7 is a flowchart illustrating an example of a process of connecting voice frame signals performed by the frame connecting unit illustrated in FIG. 1

In Operation S20 (FIG. 7), the frame connecting unit 7 determines whether the symbol of the last sample value Sb of the first frame is different from that of the first sample value Sa of the next frame. If it is determined that the symbol of the value Sb is identical to that of the value Sa, the process of the frame connecting unit 7 returns to Operation S22.

If it is determined that the symbol of the value Sb is different from that of the value Sa, in Operation S21, the frame connecting unit 7 inverts the symbol of each sample in the next frame. In this way, it is possible to make the values Sb and Sa close to each other, and more smoothly connect the previous frame and the next frame.

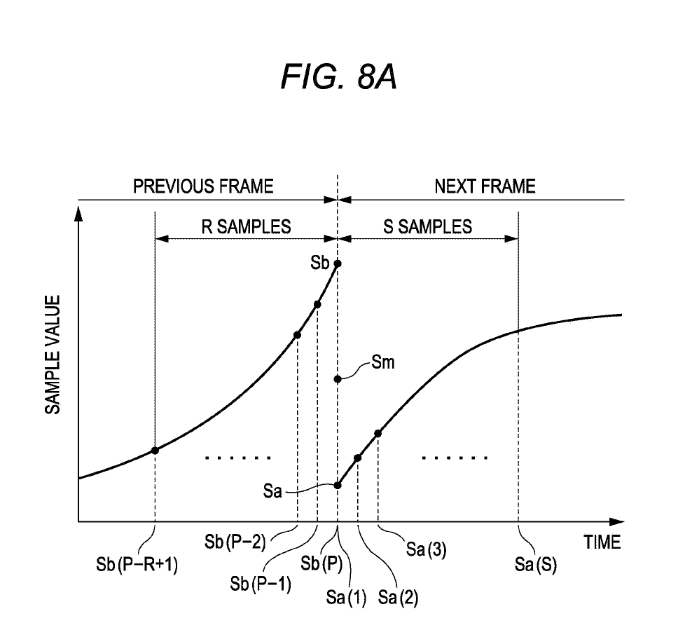

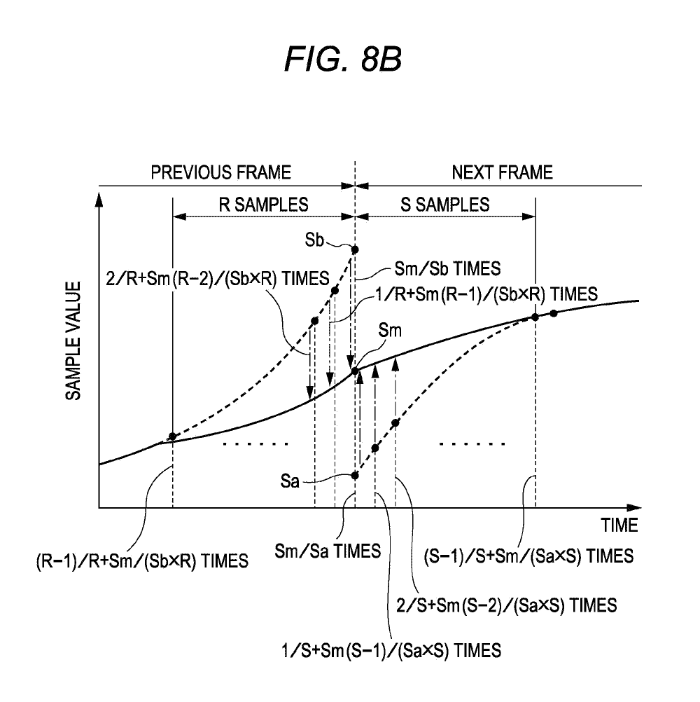

In Operation S22, the frame connecting unit 7 sets a target value Sm between the last sample value Sb of the previous frame and the first sample value Sa of the next frame. The target value Sm may be, for example, an intermediate value between the values Sb and Sa. FIG. 8A illustrates the R samples from the rear end of the previous frame at times Sb(P−R+1), . . . , Sb(P−2), Sb(P−1), and Sb(P), the S samples from the head of the next frame at times Sa(1), Sa(2), Sa(3), . . . , Sa(S), and the target value Sm.

In Operation S23, the frame connecting unit 7 makes the R samples from the rear end of the previous frame close to the target value Sm. Specifically, the values of the R samples from the rear end of the previous frame at the time Sb(P−R+j) are multiplied by (1+(Sm/Sb−1)×j/R) (j=1 to R). In the multiplication process, the R samples from the rear end of the previous frame are multiplied by a coefficient that is changed from 1 to Sm/Sb as it is close to the rear end of the frame, and the values of the samples gradually approach the target value Sm. FIG. 8B illustrates the previous frame subjected to the multiplication process performed in Operation S23.

In Operation S24, the frame connecting unit 7 makes the S samples from the head of the next frame close to the target value Sm. Specifically, the values of the S samples from the head of the next frame at a time Sa(j) are multiplied by (Sm/Sa+(1−Sm/Sa)×(j−1)/S) (j=1 to S). In the multiplication process, the S samples from the rear end of the next frame are multiplied by a coefficient that is changed from 1 to Sm/Sb as it is close to the head of the frame, and the values of the samples gradually approach the target value Sm. FIG. 8B illustrates the next frame subjected to the multiplication process performed in Operation S23.

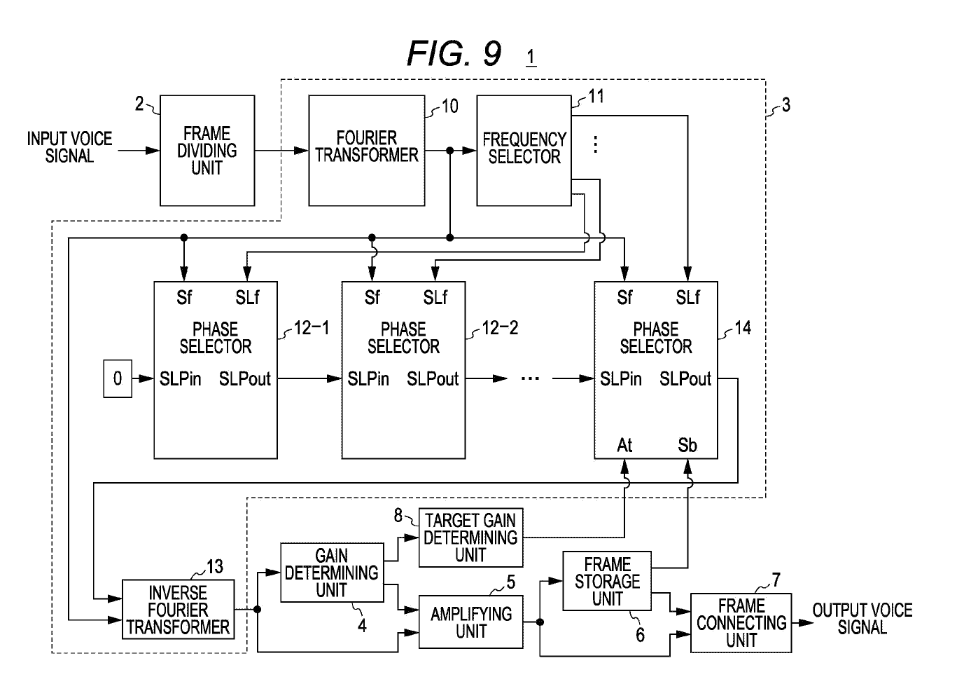

FIG. 9 illustrates a structure of a voice processing apparatus according to a an embodiment of the invention. The structure of the voice processing apparatus 1 illustrated in FIG. 9 is similar to that illustrated in FIG. 1. The same components as those in FIG. 1 are denoted by the same reference numerals, and a description of the same functions as those in FIG. 1 will be omitted.

The voice processing apparatus 1 includes a target gain determining unit 8 that determines a target gain At, which is a target value when the gain of the voice frame signal is determined. For example, the target gain determining unit 8 may determine, as the target gain At, the gain determined by the gain determining unit 4 when the voice frame signal of the previous frame is amplified. Alternatively, the target gain determining unit 8 may determine, as the target gain At, the gain determined by the gain determining unit 4 when the voice frame signal of the first frame is amplified after the voice processing apparatus 1 starts its operation.

The maximum value reducing unit 3 includes (M−1) phase selecting units 12-1, 12-2, . . . , 12-(M−1), each of which is the same as the phase selecting unit 12-1 illustrated in FIG. 2, connected in series to each other and a phase selecting unit 14 that is in the last stage and is connected to the last phase selecting unit 12-(M−1).

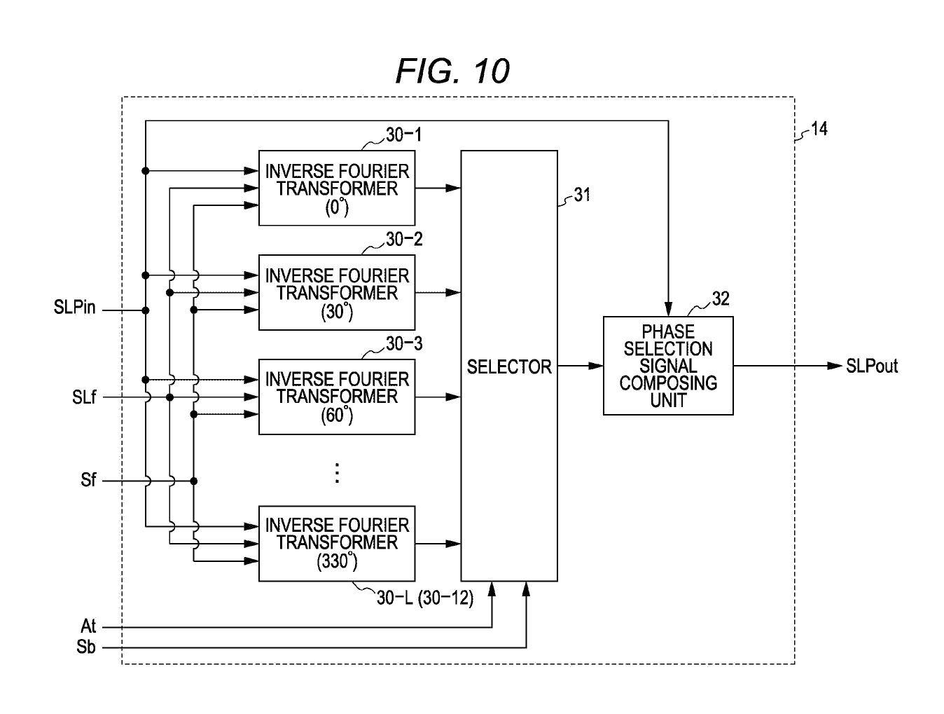

FIG. 10 is a diagram illustrating an example of a structure of the phase selecting unit illustrated in FIG. 9. A frequency domain signal output from the Fourier transformer 10 is input as an input Sf to the phase selector 14, and a signal indicating the M-th highest frequency output from the frequency selector 11 is input as an input SLf to the phase selector 14. In addition, a phase selection signal output as an output SLPout from the phase selecting unit 12-(M−1) is input as an input SLPin to the phase selector 14.

The phase selector 14 includes inverse Fourier transformers 30-1 to 30-L operated in the same way as the inverse Fourier transformers 20-1 to 20-L illustrated in FIG. 2, a phase selection signal composing unit 32 operated in the same way as the phase selection signal composing unit 22 illustrated in FIG. 2, and a selector 31. In this embodiment, a natural number L is 12. However, the natural number L may be other values equal to or greater than 2.

The target gain At determined by the target gain determining unit 8 and the last sample value Sb of the previous frame stored in the frame storage unit 6 are input to the phase selector 14. The selector 31 receives the voice frame signals generated by the inverse Fourier transformers 30-1 to 30-12.

The selector 31 determines whether there is a phase shift amount satisfying predetermined selection condition(s) among the phase shift amounts given to the voice frame signals, on the basis of the maximum amplitude value of each of the voice frame signals generated by the inverse Fourier transformers 30-1 to 30-12.

The predetermined selection conditions for selecting the phase shift amount are that there is a gain A satisfying at least the following exemplary conditions (1) to (3) when a phase shift amount is given to a frequency component of the frequency f designated by the input SLf in the voice frame signal and the phase shift amounts designated by the previous phase selecting units are given to frequency components other than the frequency f.

(1) The gain A exists in a predetermined allowable range from the target gain At. The predetermined allowable range is from At×(1−b %) to At×(1+b %). The b indicates a predetermined constant.

(2) The amplifying unit 5 can amplify the voice frame signal at the gain A without any clipping distortion in the signal waveform.

(3) When the voice frame signal is amplified at the gain A, the first sample value Sa of the voice frame signal is within a predetermined allowable range from the first sample value Sb of the previous frame. The predetermined allowable range is from Sb×(1−Q %) to Sb×(1+Q %). The Q indicates a predetermined constant.

The selector 31 selects a phase shift amount given to the voice frame signal whose maximum amplitude value is the minimum, among the voice frame signals given the phase shift amount satisfying the predetermined selection conditions. The selector 31 outputs a phase selection signal indicating the selected phase shift amount given to the voice frame signal to the phase selection signal composing unit 32.

When the selector 31 selects the phase shift amount in this way, the difference between the gain given to the voice frame signal that is currently being processed and the gain given to the previous frame can fall within a predetermined range. Therefore, it is difficult for the user to sense a variation in sound volume.

When the phase shift amount is selected in this way, the difference between the first sample value Sa of the voice frame signal that is currently being processed and the last sample value Sb of the previous frame can fall within a predetermined range. Therefore, it is difficult for the user to sense a connection point between the frames.

The phase selection signal composing unit 32 composes the phase selection signal input as the input SLPin and the phase selection signal output from the selector 31, and outputs the composed phase selection signal as the output SLPout to the inverse Fourier transformer 13.

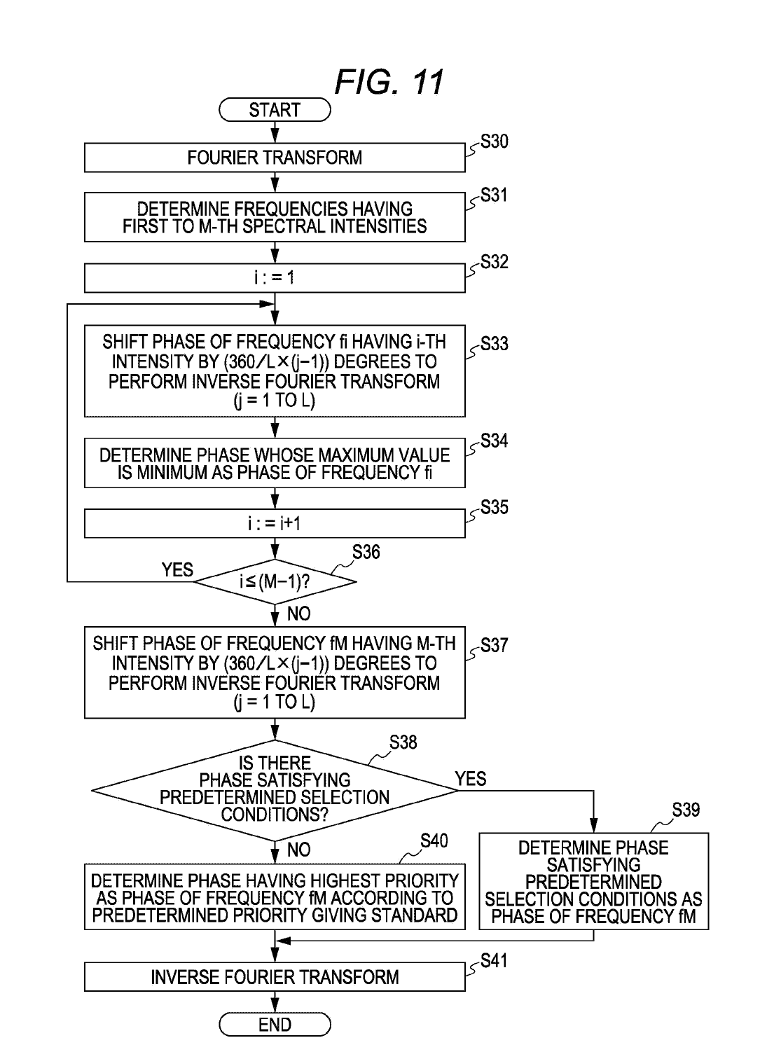

FIG. 11 is a flowchart illustrating an example of the process of reducing a maximum value of the voice signal.

In Operations S30 to S36, the phases given to the frequency components of the first to (M−1)-th frequencies are selected, similar to Operations S10 to S16 illustrated in FIG. 4 in which the phases given to the frequency components of the first to (M−1)-th frequencies are selected.

In Operation S37, the M-th phase selector 14 receives a signal indicating a frequency fM having the M-th spectral intensity as the input SLf.

The inverse Fourier transformer 30-j (j=1 to 12) of the phase selector 14 gives each phase shift amount designated by the phase selection signal input from the previous phase selecting unit 12-(M−1) to the frequency components other than the frequency fM, among the frequency components output from the Fourier transformer 10, and gives a phase shift of (360/L×(j−1)) degrees to the frequency components of the frequency fM to perform inverse Fourier transform on the time domain signal.

In Operation S38, the selector 31 of the phase selector 14 determines whether there is a phase shift amount satisfying the above-mentioned predetermined selection conditions among the phase shift amounts given to the voice frame signals generated by the inverse Fourier transformers 30-1 to 30-12.

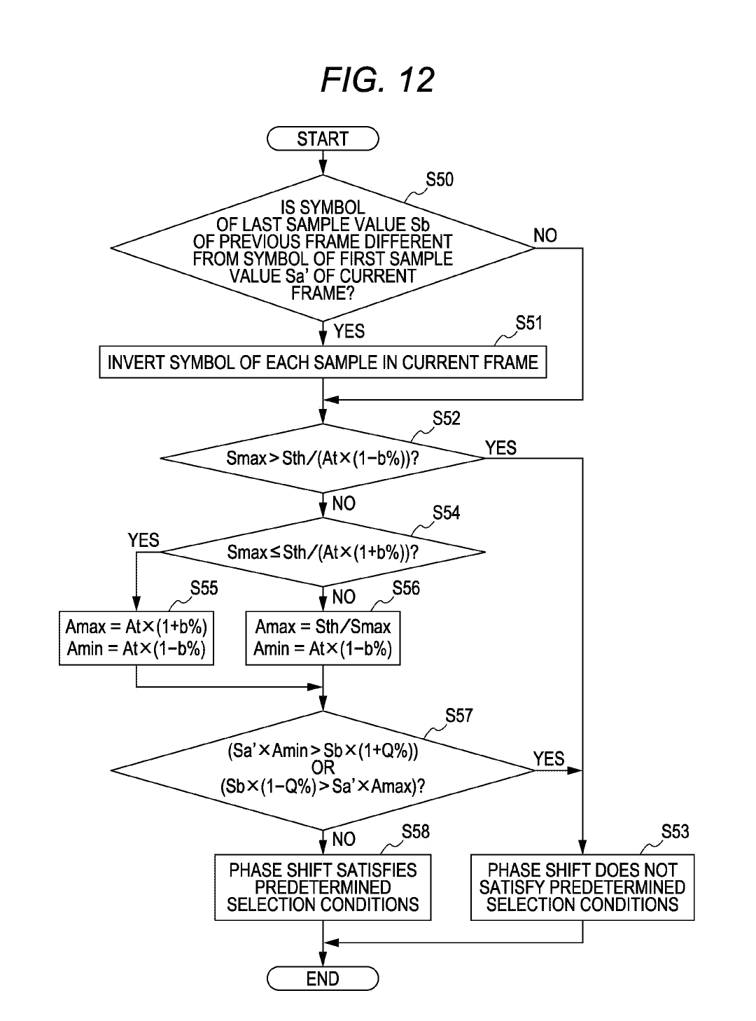

FIG. 12 is a flowchart illustrating a process of determining whether a phase shift amount satisfies the predetermined selection conditions. In Operation S50, the selector 31, for example, determines whether the symbol of the last sample value Sb of the previous frame is different from that of the first sample value Sa′ of the current frame whose phase has been shifted. If it is determined that the symbol of the value Sb is identical to that of the value Sa′, the process of the selector 31 proceeds to Operation S52.

If it is determined that the symbol of the value Sb is different from that of the value Sa′, in Operation S51, the frame connecting unit 7 inverts the symbol of each sample in the current frame. In this way, the difference between the values Sb and Sa′ is reduced.

In Operation S52, the selector 31 determines whether the maximum amplitude value Smax of the voice frame signal is greater than a predetermined value (Sth/(At×(1−b %)) on the basis of the maximum allowable output amplitude value Sth of the amplifying unit 5 and the maximum amplitude value Smax of the voice frame signal. In this way, the selector 31 determines whether the maximum gain (Sth/Smax) at which no clipping distortion occurs in the amplified voice frame signal is less than the lower limit (At×(1−b %)) of a predetermined allowable range.

When Smax>(Sth/(At×(1−b %)), the process of the selector 31 proceeds to Operation S53. When Smax>(Sth/(At×(1−b %)) is not satisfied, the process of the selector 31 proceeds to Operation S54. In Operation S53, the selector 31 determines that the phase shift does not satisfy the predetermined selection conditions, and ends the determining process.

In Operation S54, the selector 31 determines whether Smax≦(Sth/(At×(1+b %)) is satisfied to determine whether the maximum gain (Sth/Smax) at which no clipping distortion occurs in the amplified voice frame signal is equal to or greater than the upper limit (At×(1−b %)) of a predetermined allowable range.

When Smax≦(Sth/(At×(1+b %)), the process of the selector 31 proceeds to Operation S55. In Operation S55, the selector 31 sets the upper limit Amax of the gain of the amplifying unit 5 to (At×(1+b %)), and sets the lower limit Amin thereof to (At×(1−b %)). Then, the process of the selector 31 proceeds to Operation S57.

It is determined in Operation S54 that Smax≦(Sth/(At×(1+b %)) is not satisfied, the process of the selector 31 proceeds to Operation S56. In Operation S56, the selector 31 sets the upper limit Amax to the maximum gain (Sth/Smax) and the lower limit Amin to (At×(1−b %)). Then, the process of the selector 31 proceeds to Operation S57.

In Operation S57, the selector 31 determines the range of the first sample value when the current voice frame signal is amplified at a gain in the range of the lower limit Amin to the upper limit Amax set in Operation S55 or S56. When the first sample value of the current voice frame signal before amplification is Sa′, the range of the first sample value of the current voice frame signal after amplification is from Sa′×Amin to Sa′×Amax.

The selector 31 determines whether a predetermined allowable range Sb×(1−Q %) to Sb×(1+Q %) of the first sample value Sa of the current voice frame signal after amplification overlaps the range Sa′×Amin to Sa′×Amax. When these ranges do not overlap each other, there is no gain satisfying the above-mentioned predetermined selection condition (3). Therefore, the process of the selector 31 proceeds to Operation S53. The selector 31 determines that the phase shift does not satisfy the predetermined selection conditions, and ends the determining process.

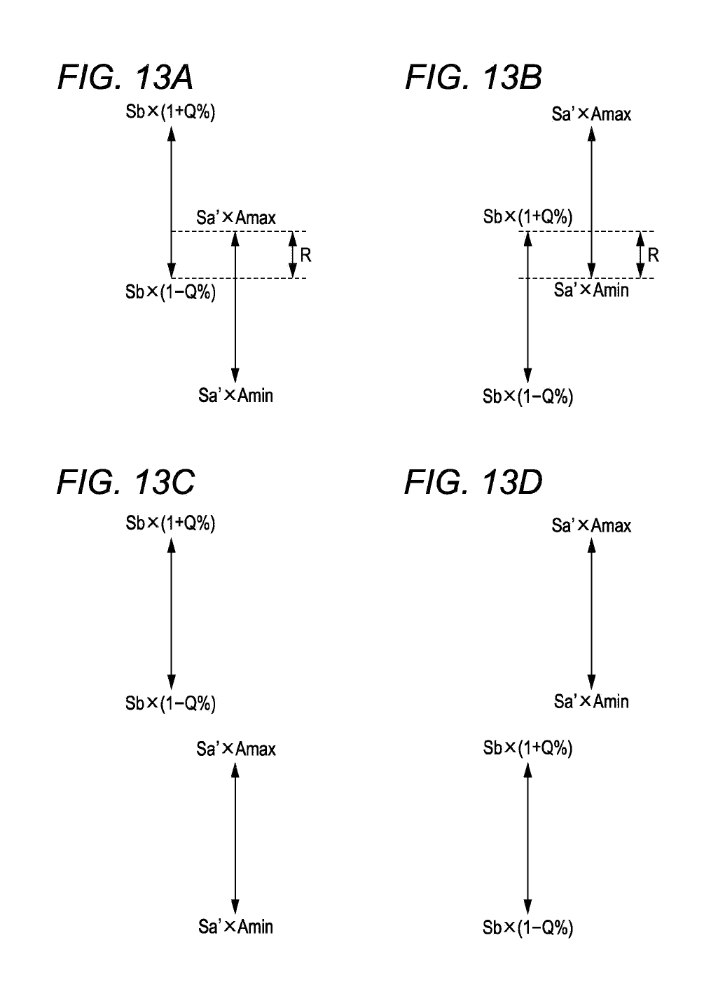

FIGS. 13A and 13B illustrate two aspects in which the range Sb(1−Q %) to Sb×(1+Q %) and the range Sa′×Amin to Sa′×Amax have an overlapping portion R therebetween, and FIGS. 13C and 13D illustrate two aspects in which the range Sa′×Amin to Sa′×Amax does not overlap the range Sb(1−Q %) to Sb×(1+Q %). As can be seen from FIGS. 13A to 13D, when Sa′×Amin>Sb×(1+Q %) or Sb×(1−Q %)>Sa′×Amax, there is no overlapping portion between the two ranges.

The selector 31 determines whether (Sa′×Amin>Sb×(1+Q %)) or (Sb×(1−Q %)>Sa′×Amax) is satisfied to determine whether the range Sb×(1−Q %) to Sb×(1+Q %) overlaps the range Sa′×Amin to Sa′×Amax. If the two ranges overlap each other, the process of the selector 31 proceeds to Operation S58. In Operation S58, the selector 31 determines that the phase shift satisfies the predetermined selection conditions, and ends the determining process.

If it is determined in Operation S38 of FIG. 11 that there is a phase shift satisfying the predetermined selection conditions, the process of the selector 31 proceeds to Operation S39. If it is determined that there is no phase shift satisfying the predetermined selection conditions, the process of the selector 31 proceeds to Operation S40.

In Operation S39, the selector 31 selects a phase shift amount given to the voice frame signal whose maximum amplitude value is the minimum, among the voice frame signals given the phase shift amounts satisfying the predetermined selection conditions, thereby selecting a phase shift amount given to the frequency component of the frequency fM from the phase shift amounts satisfying the predetermined selection conditions. The selector 31 outputs a phase selection signal indicating the selected phase shift amount. The phase selection signal composing unit 32 composes the phase selection signal input as the input SLPin and the phase selection signal output from the selector 31, and outputs the composed phase selection signal as the output SLPout. Then, the process proceeds to Operation S41.

In Operation S40, the selector 31 selects, as the phase shift amount given to the frequency component of the frequency fM, a phase shift amount having the highest priority from the phase shift amounts given to the voice frame signals generated by the inverse Fourier transformers 30-1 to 30-12, on the basis of a predetermined priority giving standard. For example, the priority giving standard includes the following: when each phase shift amount is given, (1) the magnitude of the maximum amplitude value of each voice frame signal; (2) the magnitude of the distance between the range of the gain at which the amplifying unit 5 can amplify the voice frame signal without any clipping distortion and the target gain A; and (3) the magnitude of the difference between the first sample value of each voice frame signal when the amplifying unit 5 can amplify the voice frame signal without any clipping distortion and the last sample value of the previous frame.

The selector 31 outputs a phase selection signal indicating the selected phase shift amount. The phase selection signal composing unit 32 composes the phase selection signal input as the input SLPin and the phase selection signal output from the selector 31, and outputs the composed phase selection signal as the output SLPout. Then, the process proceeds to Operation S41.

In Operation S41, the inverse Fourier transformer 13 illustrated in FIG. 9 gives each phase shift amount designated by the phase selection signal output from the phase selector 14 to the frequency components output from the Fourier transformer 10 to perform inverse Fourier transform on the frequency domain signal, thereby generating a voice frame signal.

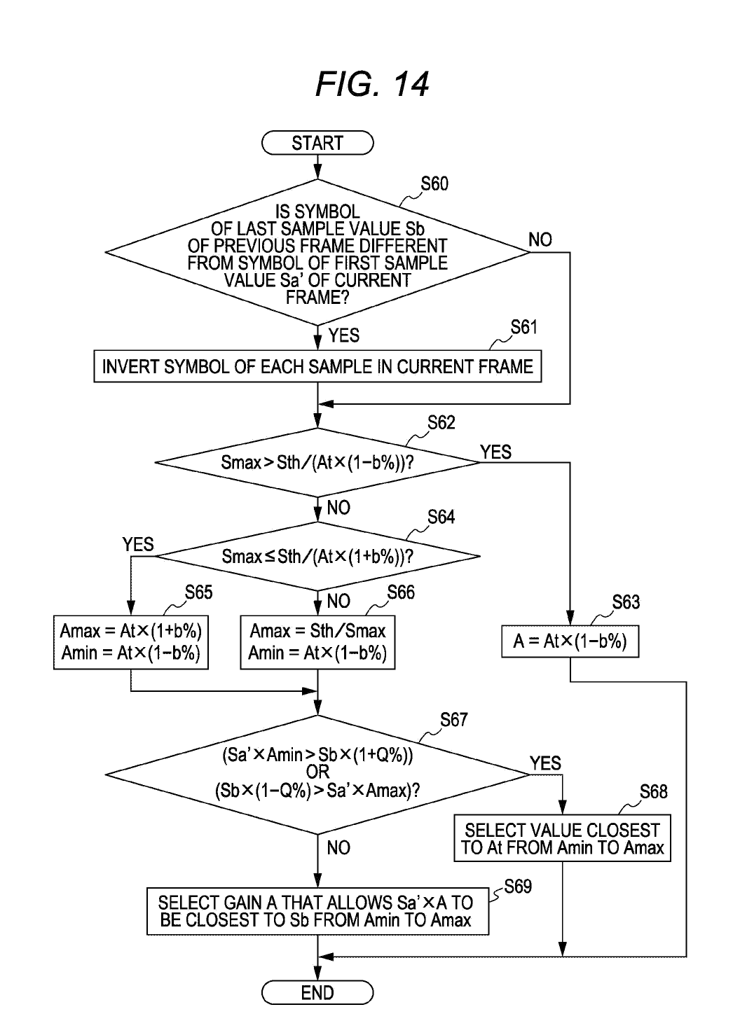

FIG. 14 is a flowchart illustrating an example of a gain determining process performed by the gain determining unit illustrated in FIG. 9. In Operation S60, the gain determining unit 4 determines whether the symbol of the first sample value Sb of the previous frame is different from that of the last sample value Sa′ of the current frame whose phase has been shifted. If it is determined that the symbol of the value Sb is identical to that of the value Sa′, the process proceeds to Operation S62. If it is determined that the symbol of the value Sb is different from that of the value Sa′, in Operation S61, the frame connecting unit 7 inverts the symbol of each sample in the current frame.

In Operation S62, the gain determining unit 4 determines whether the maximum amplitude value Smax of the voice frame signal is greater than a predetermined value (Sth/(At×(1−b %)). When Smax>(Sth/(At×(1−b %)), the process of the gain determining unit 4 proceeds to Operation S63. When Smax>(Sth/(At×(1−b %)) is not satisfied, the process proceeds to Operation S64.

When Smax>(Sth/(At×(1−b %)), the gain is less than the lower limit (At×(1−b %) of an allowable range even at the maximum amplitude value Smax where no clipping distortion occurs in the voice frame signal. Therefore, the gain determining unit 4 sets the gain A to (At×(1−b %)) in Operation S63, and ends the determining process.

In Operation S64, the gain determining unit 4 determines whether Smax (Sth/(At×(1+b %)) is satisfied. When Smax≦(Sth/(At×(1+b %)) is satisfied, the process of the gain determining unit 4 proceeds to Operation S65. In Operation S65, the gain determining unit 4 sets the upper limit Amax of the gain of the amplifying unit 5 to (At×(1+b %)), and sets the lower limit Amin thereof to (At×(1−b %)). Then, the process of the gain determining unit 4 proceeds to Operation S67.

It is determined in Operation S64 that Smax≦(Sth/(At×(1+b %)) is not satisfied, the process of the gain determining unit 4 proceeds to Operation S66. In Operation S66, the gain determining unit 4 sets the upper limit Amax to the maximum gain (Sth/Smax) and the lower limit Amin to (At×(1−b %)). Then, the process of the gain determining unit 4 proceeds to Operation S67.

In Operation S67, the gain determining unit 4 determines whether the range Sa′×Amin to Sa′×Amax of the first sample value when the current voice frame signal is amplified at a gain in the range of the lower limit Amin to the upper limit Amax set in Operation S65 or S66 overlaps a predetermined allowable range Sb×(1−Q %) to Sb×(1+Q %) of the first sample value Sa of the current voice frame signal after amplification.

If it is determined that these ranges do not overlap each other, the process of the gain determining unit 4 proceeds to Operation S68. If it is determined that these ranges overlap each other, the process of the gain determining unit 4 proceeds to Operation S69. In Operation S68, the gain determining unit 4 selects one of the gains Amin to Amax closest to the target gain At as the gain A, and ends the process.

In Operation S69, the gain determining unit 4 selects one of the gains Amin to Amax that allows the amplified value of the first sample value Sa′ of the current frame before amplification to be closest to the last sample value Sb of the previous frame. In this way, the gain determining unit 4 selects the gain that allows the first sample value Sa of the current frame after amplification to be closest to the last sample value Sb of the previous frame. Therefore, it is possible to reduce the gap between the sample values of the frames.

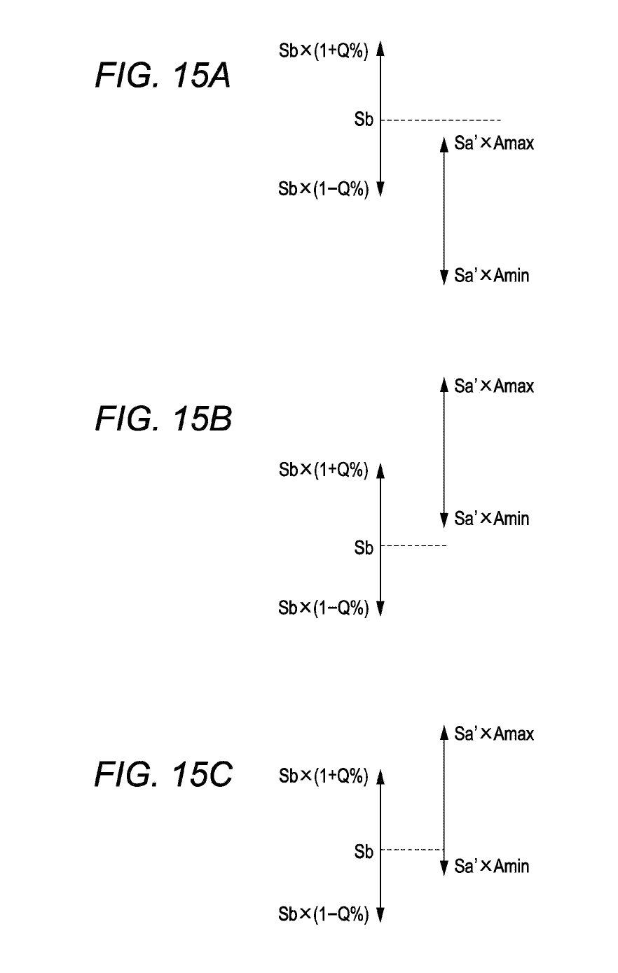

For example, as illustrated in FIG. 15A, when the range Sa′×Amin to Sa′×Amax of the first sample value of the amplified current voice frame signal is less than the last sample value Sb of the previous frame, the gain determining unit 4 selects the maximum gain Amax. As illustrated in FIG. 15B, when the range Sa′×Amin to Sa′×Amax of the first sample value of the amplified current voice frame signal is greater than the last sample value Sb of the previous frame, the gain determining unit 4 selects the minimum gain Amin.

As illustrated in FIG. 15C, when the last sample value Sb of the previous frame is within the range Sa′×Amin to Sa′×Amax of the first sample value of the amplified current voice frame signal, the gain determining unit 4 selects a gain (Sb/Sa′).

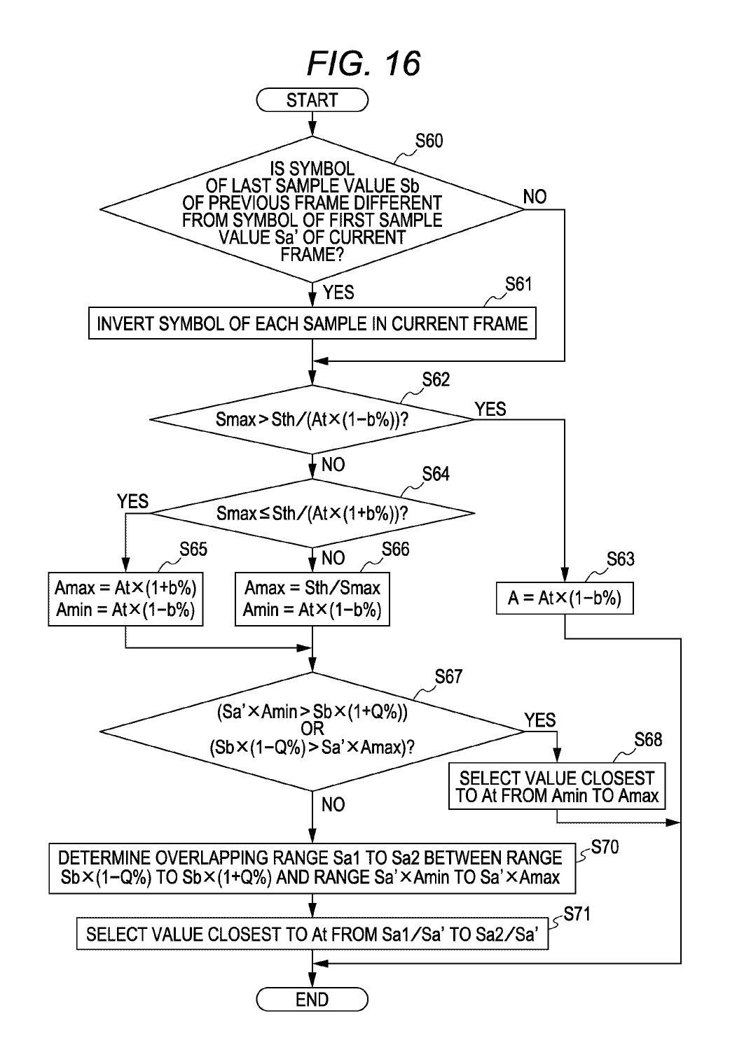

FIG. 16 is a flowchart illustrating an example of the gain determining process performed by the gain determining unit illustrated in FIG. 9. Operations S60 to S68 are the same as the determining process illustrated in FIG. 14. When it is determined in Operation S67 that the range Sa′×Amin to Sa′×Amax of the first sample value after amplification overlaps the predetermined allowable range Sb×(1−Q %) to Sb×(1+Q %), the process of the gain determining unit 4 proceeds to Operation S70.

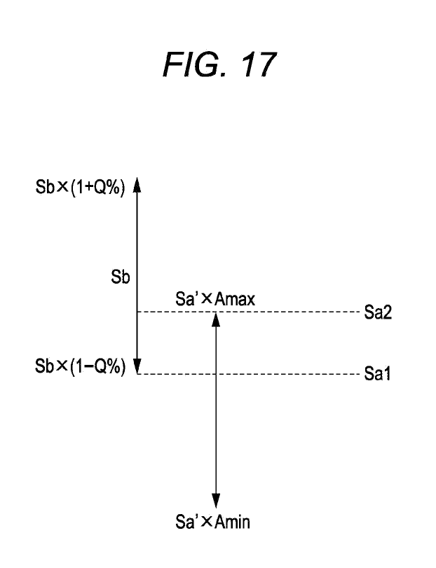

In Operation S70, the gain determining unit 4 determines an overlapping range Sa1 to Sa2 between the range Sa′×Amin to Sa′×Amax and the range Sb×(1−Q %) to Sb×(1+Q %). FIG. 17 illustrates an example of the overlapping range Sa1 to Sa2 determined by the gain determining unit 4.

In Operation S71, the gain determining unit 4 selects as the gain one of the values Sa1/Sa′ to Sa2/Sa′ that is closest to the target gain At. When the gain determining unit 4 selects the gain in this way, the above-mentioned predetermined selection conditions are satisfied, and it is possible to reduce the gap between the signal gain of the current frame and the signal gain of the previous frame.

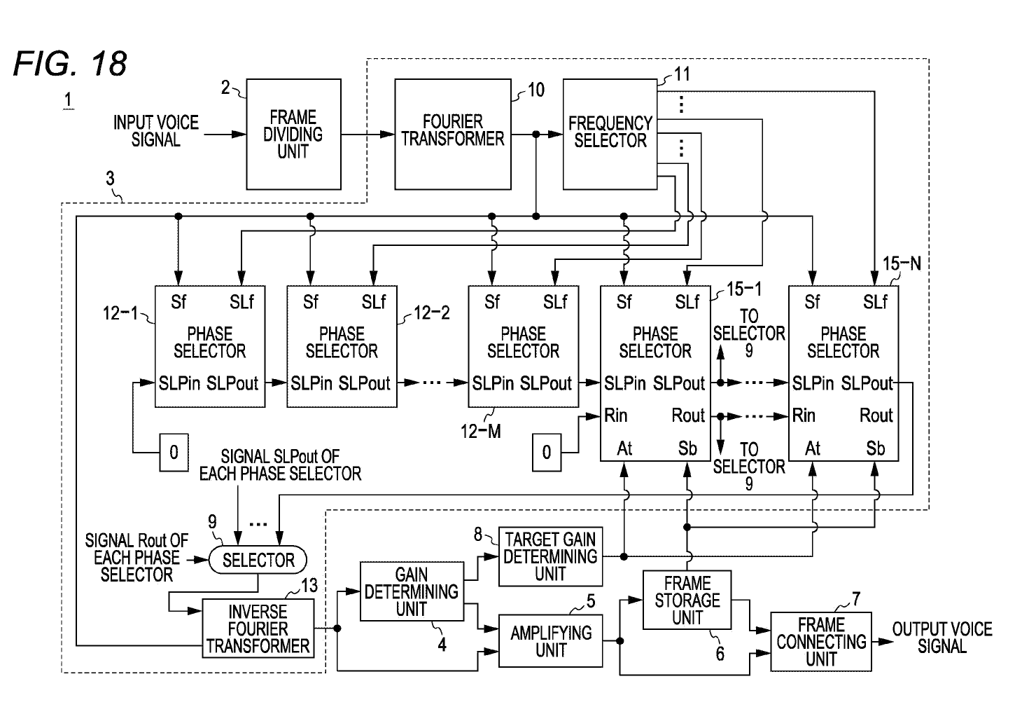

FIG. 18 illustrates a structure of a voice processing apparatus according to an embodiment of the invention. The structure of a voice processing apparatus 1 illustrated in FIG. 18 is similar to that illustrated in FIG. 9. The same components as those in FIG. 9 are denoted by the same reference numerals, and a description of the same functions as those in FIG. 9 will be omitted.

A maximum value reducing unit 3 includes M phase selecting units 12-1, 12-2, . . . , 12-M, each of which is the same as the phase selecting unit 12-1 illustrated in FIG. 2, connected in series to each other, and N phase selecting units 15-1 to 15-N that are connected to the last phase selecting unit 12-M and are connected in series to each other.

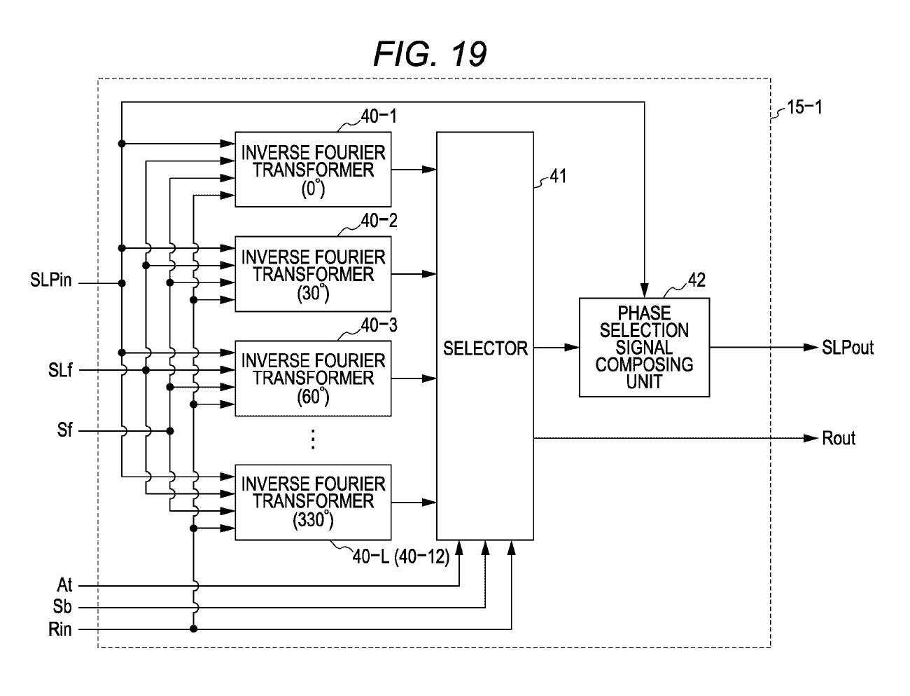

FIG. 19 is a diagram illustrating an example of the structure of a phase selecting unit illustrated in FIG. 18. The other phase selecting units 15-2 to 15-N have the same structure as the phase selecting unit 15-1. A frequency domain signal output from the Fourier transformer 10 is input to the phase selecting unit 15-i (i=1 to N) as an input Sf. A signal indicating a frequency having the (M+i)-th spectral intensity output from the frequency selector 11 is input to the phase selecting unit 15-i as an input SLf. A phase selection signal output as an output SLPout from the phase selecting unit 12-M or the phase selecting unit 15-(i−1), which is the previous phase selecting unit, is input to the phase selecting unit 15-i as an input SLPin.

The phase selecting unit 15-1 includes inverse Fourier transformers 40-1 to 40-L operated in the same way as the inverse Fourier transformers 20-1 to 20-L illustrated in FIG. 2, a phase selection signal composing unit 42 operated in the same way as the phase selection signal composing unit 22 illustrated in FIG. 2, and a selector 41. In this embodiment, a natural number L is 12. However, the natural number L may be other values equal to or greater than 2.

The target gain At determined by the target gain determining unit 8 and the last sample value Sb of the previous frame stored in the frame storage unit 6 are input to the phase selecting units 15-1 to 15-N. The selector 41 receives the voice frame signals generated by the inverse Fourier transformers 40-1 to 40-12.

The selector 41 performs the same process as that illustrated in FIG. 12 to determine whether there is a phase shift amount satisfying predetermined selection conditions among the phase shift amounts given to the voice frame signals generated by the inverse Fourier transformers 40-1 to 40-12. If it is determined that there is a phase shift amount satisfying the predetermined selection conditions, the selector 41 outputs a determination result signal having a value of “1” as an output Rout. If not, the selector 41 outputs a determination result signal having a value of “0” as the output Rout.

The phase selecting unit 15-i (i=1 to N) receives the determination result signal output as the output Rout from the previous phase selecting unit as an input Rin. The determination result signal received as the input Rin is input to the inverse Fourier transformers 40-1 to 40-12 and the selector 41.

When the value of the input determination result signal is “1”, that is, when the phase shift amount satisfying the selection conditions appears in the previous phase selecting unit 15-(i−1), the inverse Fourier transformers 40-1 to 40-12 and the selector 41 stop their operations. In this case, the selector 41 sets the value of the output Rout to “1”. However, a value of “0” is input to the input Rin of the (M+1)-th phase selecting unit 15-1.

The selector 41 of the phase selecting unit 15-i (i=1 to N) selects a phase shift amount given to the frequency component of a frequency f(M+i) of the voice frame signal whose maximum amplitude value is the minimum among the voice frame signals given the phase shift amounts satisfying the predetermined selection condition(s). The selector 41 outputs a phase selection signal indicating the selected phase shift amount given to the voice frame signal to the phase selection signal composing unit 42. The phase selection signal composing unit 42 composes the phase selection signal input as the input SLPin and the phase selection signal output from the selector 41, and outputs the composed phase selection signal as the output SLPout.

The phase selection signals output from the previous phase selecting units 15-1 to 15-(N−1) are input as the inputs SLPin to the next phase selecting units 15-2 to 15-N. In addition, the phase selection signals output from the phase selecting units 15-1 to 15-N are input to a selector 9.

As illustrated in FIG. 18, the selector 9 uses the determination result signal output from each phase selecting unit 15-i (i=1 to N) as a selection signal to select the phase selection signal output as the output SLPout from the first phase selecting unit among the phase selecting units 15-i that output the determination result signal having a value of “1”, and outputs the selected signal to the inverse Fourier transformer 13.

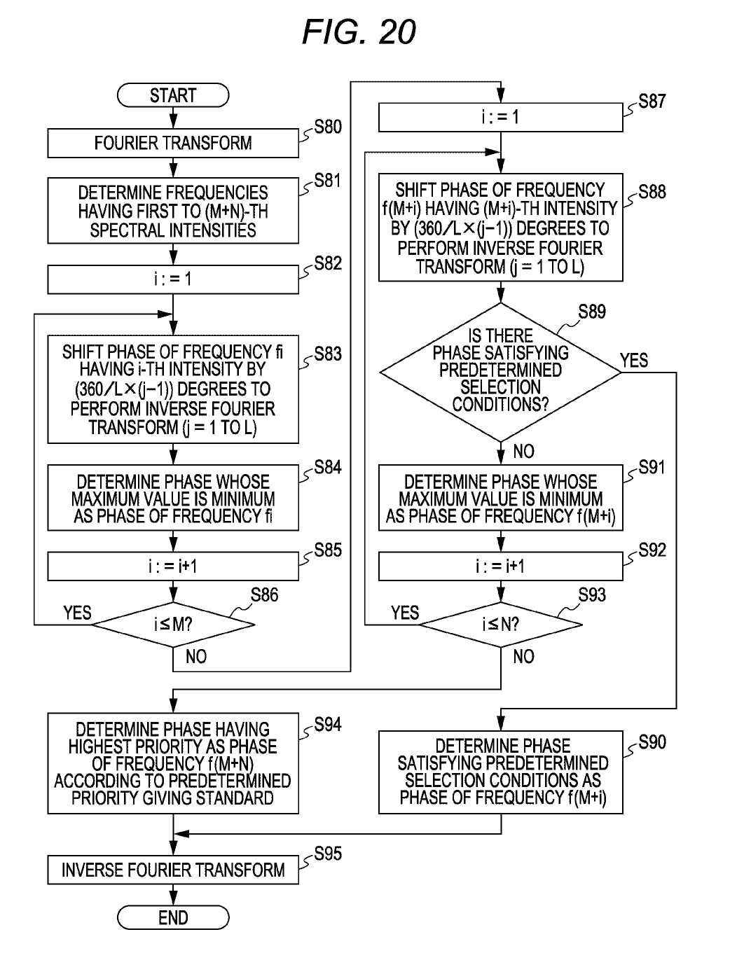

FIG. 20 is a flowchart illustrating an example of a process of reducing a maximum value of the voice signal. In Operations S80 to S86, similar to Operations S10 to S16 illustrated in FIG. 4 in which the phase shift amounts given to the frequency components of the first to M-th frequencies are selected, the phase shift amounts given to the frequency components of the first to M-th frequencies are selected. However, in Operation S81, the frequency selector 11 determines the frequencies fi (i=1 to M+N) having the first to (M+N)-th highest spectral intensities.

In Operation S87, a value of the index variable i is initialized to “1” with reference to each phase selecting unit 15-i (i=1 to N).

In Operation S88, the (M+i)-th phase selecting unit 15-i receives a signal indicating a frequency f(M+i) having the (M+i)-th spectral intensity as the input SLf.

The inverse Fourier transformer 40-j (j=1 to 12) of the phase selecting unit 15-i gives each phase shift amount designated by the phase selection signal input from the previous phase selecting unit 15-(i−1) to the frequency components other than the frequency f(M+i) designated by the input SLf, among the frequency components output from the Fourier transformer 10, and gives a phase shift of (360/L×(j−1)) degrees to the frequency components of the frequency f(M+i) to perform inverse Fourier transform on the time domain signal.

In Operation S89, the selector 41 of the phase selecting unit 15-i determines whether there is a phase shift amount satisfying the above-mentioned predetermined selection conditions among the phase shift amounts given to the voice frame signals generated by the inverse Fourier transformers 40-1 to 40-12. A process of determining whether the phase shift amount satisfies the predetermined selection conditions may be the same as that illustrated in FIG. 12.

If it is determined in Operation S89 that there is a phase shift amount satisfying the predetermined selection conditions, the process of the selector 41 proceeds to Operation S90. If it is determined that there is no phase shift amount satisfying the predetermined selection conditions, the process of the selector 41 proceeds to Operation S91.

In Operation S90, the selector 41 selects a phase shift amount given to the frequency component of the frequency f(M+i) by the same method as that in Operation S39 illustrated in FIG. 11. The selector 41 outputs a phase selection signal indicating the selected phase shift amount. The phase selection signal composing unit 42 composes the phase selection signal input as the input SLPin and the phase selection signal output from the selector 41, and outputs the composed phase selection signal as the output SLPout. Then, the process proceeds to Operation S95.

In Operation S91, the selector 41 selects a voice frame signal whose maximum amplitude value is the minimum among the voice frame signals generated by the inverse Fourier transformers 40-1 to 40-12. The selector 41 outputs a phase selection signal indicating the phase shift amount given to the frequency component f(M+i) of the voice frame signal selected from the voice frame signals generated by the inverse Fourier transformers 40-1 to 40-12. The phase selection signal composing unit 42 composes the phase selection signal input as the input SLPin and the phase selection signal output from the selector 41, and outputs the composed phase selection signal as the output SLPout.

In Operation S92, the value of the index variable i is increased by one. In Operation S93, when the value of the index variable i is equal to or less than “N”, that is, when there is a phase selecting unit that does not complete a phase selection process, the process returns to Operation S88, and Operations S88 to S93 are repeatedly performed.

If it is determined in Operation S93 that the value of the index variable i is greater than “N”, the process proceeds to Operation S94. In Operation S94, the selector 41 selects a phase shift amount given to the frequency component of a frequency f(M+N) by the same method as that in Operation S40 illustrated in FIG. 11. Then, the process proceeds to Operation S95.

In Operation S95, the selector 9 illustrated in FIG. 18 uses the determination result signal output from each phase selecting unit 15-i (i=1 to N) as a selection signal to select one of the phase selection signals output from the phase selecting units 15-i, and outputs the selected signal to the inverse Fourier transformer 13. The inverse Fourier transformer 13 gives the phase shift amount designated by the input phase selection signal to each frequency component received from the Fourier transformer 10 to perform inverse Fourier transform on the frequency domain signal, thereby generating a voice frame signal.

According to this embodiment, when it is easy to determine the phase shift amount of the voice frame signal satisfying predetermined selection conditions, it is possible to determine the phase shift amount of the voice frame signal with a small amount of calculation using a relatively small number of phase selecting units. On the other hand, when it is difficult to determine the phase shift amount of a voice frame signal satisfying predetermined selection conditions, it is possible to determine the appropriate phase shift amount of the voice frame signal by dynamically increasing the number of phase selecting units.

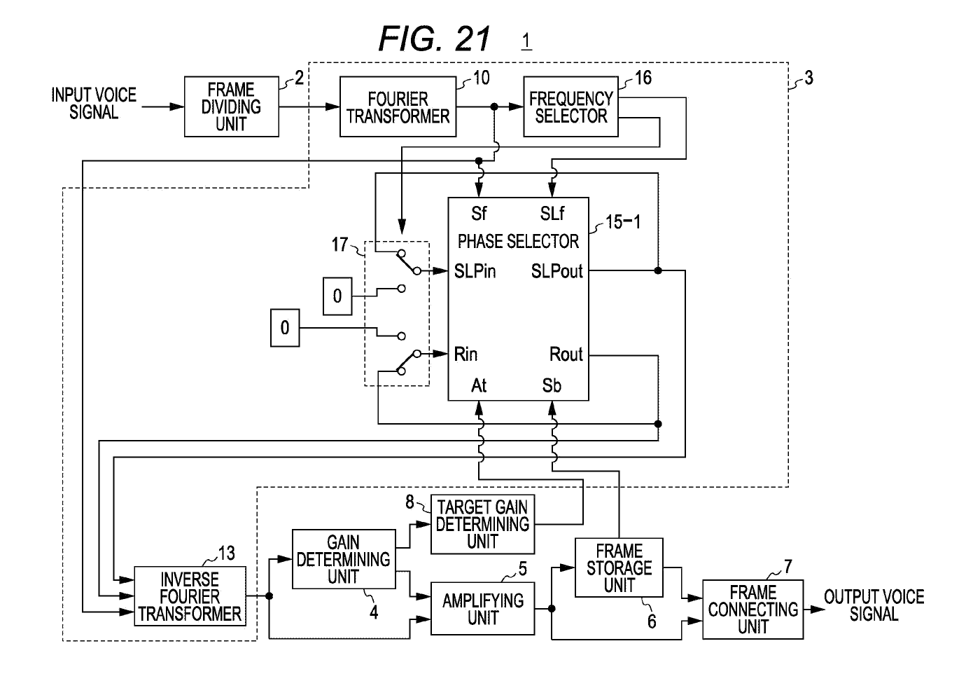

FIG. 21 is a diagram illustrating a structure of a voice processing apparatus according to an embodiment of the invention. FIG. 21 illustrates a voice processing apparatus 1 according to an embodiment of the invention. The structure of the voice processing apparatus 1 illustrated in FIG. 21 is similar to that illustrated in FIG. 18. The same components as those in FIG. 18 are denoted by the same reference numerals, and a description of the same functions as those in FIG. 18 will be omitted.

A Fourier transformer 10 performs Fourier transform on a voice frame signal to generate frequency domain signals indicating the frequency components of M frequencies fi (i=1 to M) of the voice frame signal. A frequency selecting unit 16 sequentially inputs signals indicating the frequencies fi as inputs SLf to a phase selecting unit 15-1 in descending order of spectral intensity on the basis of the spectral intensity of each frequency component output from the Fourier transformer 10.

A maximum value reducing unit 3 includes the phase selecting unit 15-1 illustrated in FIG. 18. The phase selecting unit 15-1 feeds back a phase selection signal and a determination result signal, which are respectively output as an output SLPout and an output Rout, as an input SLPin and an input Rin.

The phase selecting unit 15-1 feeds back the phase selection signal output as the output SLPout when selecting a phase shift amount given to the frequency component of the frequency fi having an i-th spectral intensity as the input SLPin when selecting a phase shift amount given to the frequency component of a frequency f(i+1) having an (i+1)-th spectral intensity.

In addition, the phase selecting unit 15-1 feeds back the determination result signal output as the output Rout when selecting a phase shift amount given to the frequency component of the frequency fi as the input Rin when selecting a phase shift amount given to the frequency component of the frequency f(i+1).

The maximum value reducing unit 3 includes a switch 17. When a phase shift amount given to the frequency component of the first frequency f1 is selected, the switch 17 inputs “0” to the input Rin and inputs a phase selection signal that does not designate a phase shift amount given to all the frequency components to the input SLPin.

The phase selection signal and the determination result signal respectively output as the output SLPout and the output Rout from the phase selecting unit 15-1 are input to the inverse Fourier transformer 13. The inverse Fourier transformer 13 gives the phase shift amount designated by the phase selection signal input when the value of the determination result signal is “1” to each frequency component output from the Fourier transformer 10 to perform inverse Fourier transform on the frequency domain signal, thereby generating a voice frame signal.

The maximum value reducing unit 3 according to this embodiment can use one phase selecting unit 15-1 to select each phase shift amount to be given to the frequency components of the frequencies f1 to fM until a phase shift amount satisfying the predetermined selection conditions is detected or the phase shift amounts of all the frequency components f1 to fM of the M frequencies generated by the Fourier transformer 10 are determined.

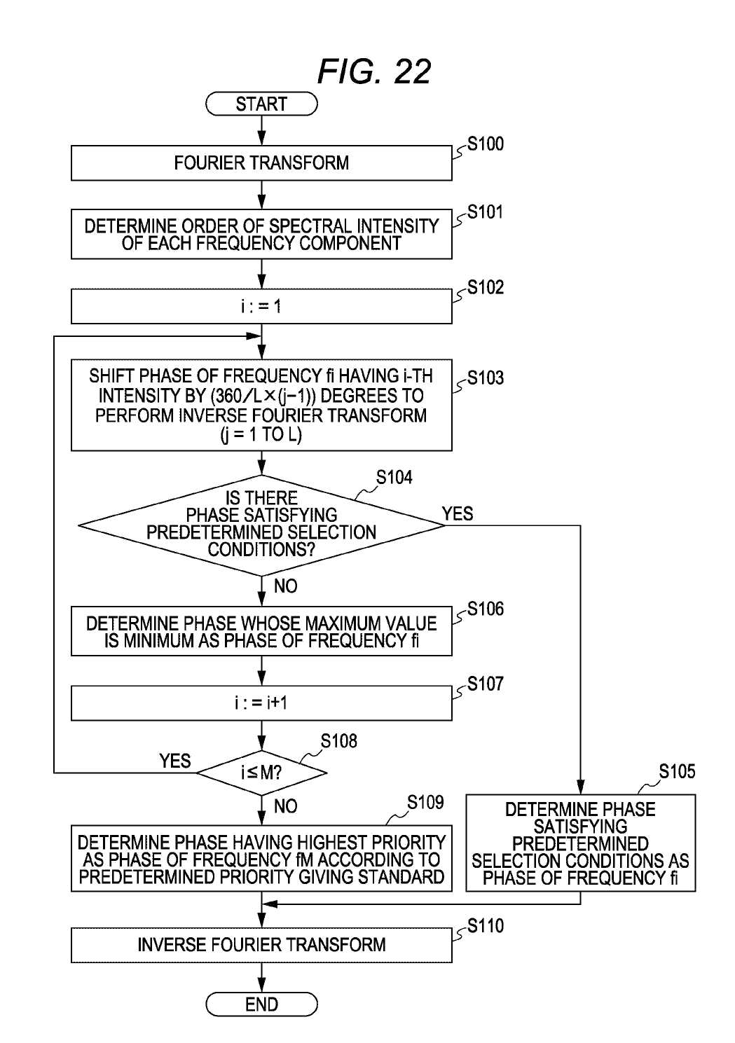

FIG. 22 is a flowchart illustrating an example of a process of reducing a maximum value of a voice signal. In Operation S100, the Fourier transformer 10 illustrated in FIG. 21 performs Fourier transform on the voice frame signal to generate frequency domain signals indicating the frequency components of the M frequencies fi (i=1 to M) of the voice frame signal.

In Operation S101, the frequency selecting unit 16 determines the input order of the signals indicating the frequencies fi to the phase selecting unit 15-1 in descending order of the spectral intensity, on the basis of the spectral intensity of the frequency component of each frequency fi. In Operation S102, the value of an index variable i referring to the frequencies fi having the first to M-th spectral intensities is initialized to “1”.

In Operation S103, the phase selecting unit 15-1 receives a signal indicating the frequency fi having the i-th highest spectral intensity included in the frequency domain signal output from the Fourier transformer 10 as the input SLf.

The Inverse Fourier transformer 40-j (j=1 to 12) of the phase selecting unit 15-1 gives the phase shift amount, designated by the phase selection signal output as the output SLPout when a phase shift amount given to the frequency f(i−1) is selected, to the frequency components other than the frequency fi designated by the input SLf, and gives a phase shift of (360/L×(j−1)) degrees to the frequency component of the frequency fi to perform inverse Fourier transform on the time domain signal.

In Operation S104, the selector 41 of the phase selecting unit 15-1 determines whether there is a phase shift amount satisfying the above-mentioned predetermined selection conditions among the phase shift amounts given to the voice frame signals generated by the inverse Fourier transformers 40-1 to 40-12. A process of determining whether the phase shift amount satisfies the predetermined selection conditions may be the same as that illustrated in FIG. 12.

If it is determined in Operation S104 that there is a phase shift amount satisfying the predetermined selection conditions, the process of the selector 41 proceeds to Operation S105. If it is determined that there is no phase shift amount satisfying the predetermined selection conditions, the process of the selector 41 proceeds to Operation S106. In Operation S105, the selector 41 selects a phase shift amount to be given to the frequency component of the frequency fi by the same method as that in Operation S39 illustrated in FIG. 11.

The selector 41 outputs a phase selection signal indicating the selected phase shift amount. The phase selection signal composing unit 42 composes the phase selection signal input as the input SLPin and the phase selection signal output from the selector 41, and outputs the composed phase selection signal as the output SLPout. In addition, the selector 41 changes the value of the determination result signal from “0” to “1”. Then, the process proceeds to Operation S110.

In Operation S106, the selector 41 selects a voice frame signal whose maximum amplitude value is the minimum among the voice frame signals generated by the inverse Fourier transformers 40-1 to 40-12. The selector 41 outputs a phase selection signal indicating the phase shift amount given to the frequency component fi of the voice frame signal selected from the voice frame signals generated by the inverse Fourier transformers 40-1 to 40-12. The phase selection signal composing unit 42 composes the phase selection signal input as the input SLPin and the phase selection signal output from the selector 41. The phase selection signal composing unit 42 outputs the composed phase selection signal as the output SLPout.

In Operation S107, the value of the index variable i is increased by one. In Operation S108, when the value of the index variable i is equal to or less than “M”, that is, when there is a frequency to be subjected to the phase selecting process, the process returns to Operation S103, and Operations S103 to S108 are repeatedly performed.

If it is determined in Operation S108 that the value of the index variable i is greater than “M”, the process proceeds to Operation S109. In Operation S109, the selector 41 selects a phase shift amount to be given to the frequency component of the frequency fM, similar to Operation S40 illustrated in FIG. 11.

The selector 41 outputs a phase selection signal indicating the selected phase shift amount. The phase selection signal composing unit 42 composes the phase selection signal input as the input SLPin and the phase selection signal output from the selector 41, and outputs the composed phase selection signal as the output SLPout. In addition, the selector 41 changes the value of the determination result signal from “0” to “1”. Then, the process proceeds to Operation S110.

In Operation S110, the inverse Fourier transformer 13 illustrated in FIG. 21 gives the phase shift amount designated by the phase selection signal input when the value of the determination result signal is “1” to each frequency component output from the Fourier transformer 10 to perform inverse Fourier transform on the frequency domain signal, thereby generating a voice frame signal.

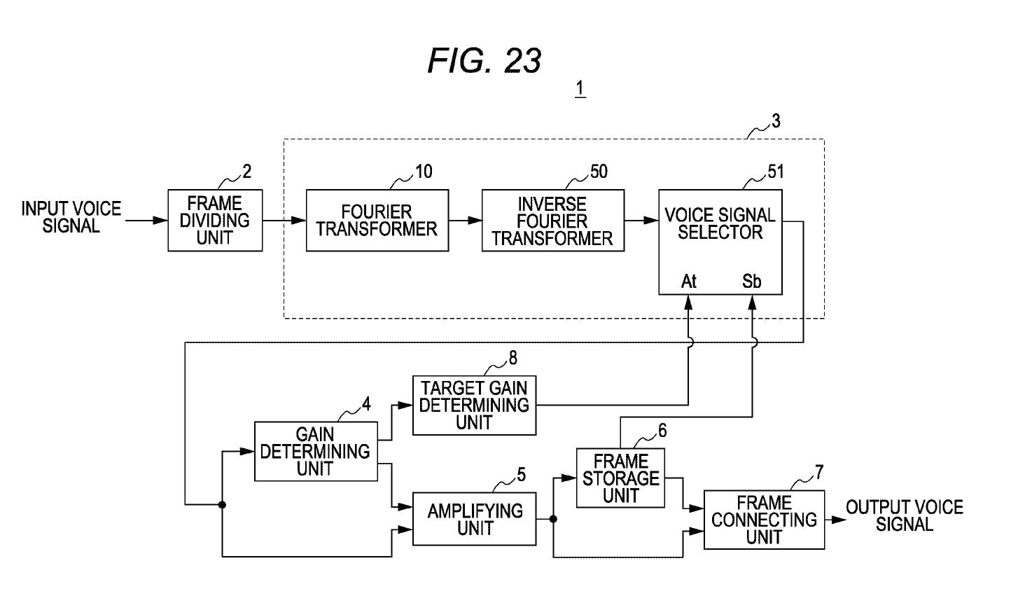

FIG. 23 is a diagram illustrating a structure of a voice processing apparatus according to an embodiment of the invention. FIG. 23 illustrates a voice processing apparatus according to an embodiment of the invention. The structure of the voice processing apparatus 1 illustrated in FIG. 23 is similar to that illustrated in FIG. 18. The same components as those in FIG. 18 are denoted by the same reference numerals, and a description of the same functions as those in FIG. 18 will be omitted.

A maximum value reducing unit 3 includes a Fourier transformer 10, an inverse Fourier transformer 50, and a voice signal selecting unit 51. The Fourier transformer 10 performs Fourier transform on a voice frame signal to generate frequency domain signals indicating the frequency components of K frequencies fi (i=1 to K) of the voice frame signal.

The inverse Fourier transformer 50 gives each of the combinations of plural kinds of phase shift amounts Δθj>(360/L×(j−1)) (j=1 to L) degrees to all the frequency components of the K frequencies fi (i=1 to K) to perform inverse Fourier transform on the frequency domain signals, thereby generating LK voice frame signals.

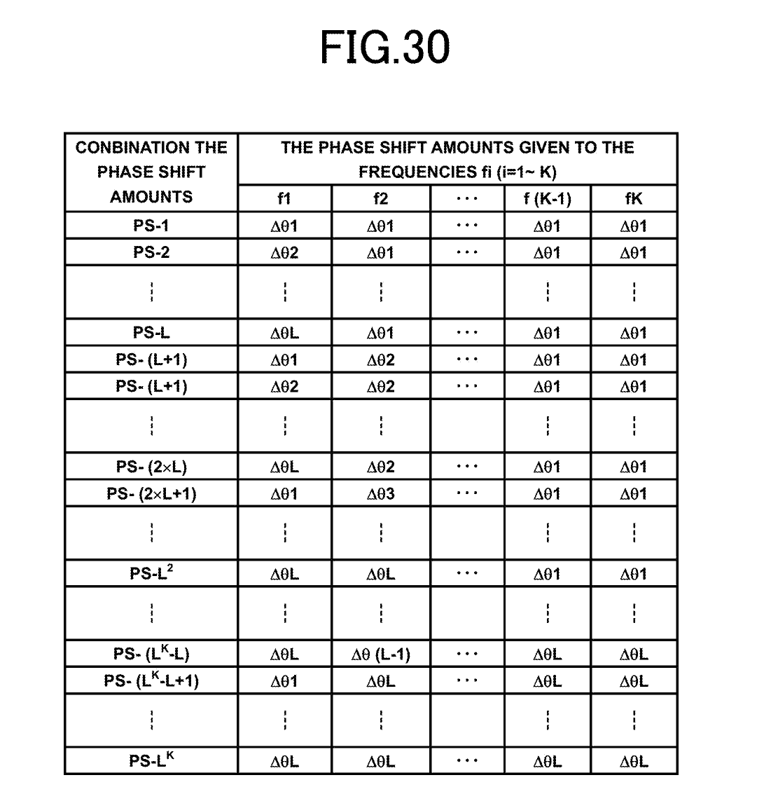

The inverse Fourier transformer 50 gives LK combinations PS-1 to PS-LK of phase shift amounts to the frequency components to perform inverse Fourier transform on the frequency domain signals, thereby generating LK voice frame signals. The phase shift amounts given to the frequency components of the frequencies fi are illustrated in FIG. 30.

The target gain At determined by the target gain determining unit 8 and the last sample value Sb of the previous frame stored in the frame storage unit 6 are input to the voice signal selecting unit 51. The voice signal selecting unit 51 determines whether there is a voice frame signal satisfying predetermined selection conditions among the voice frame signals generated by the inverse Fourier transformer 50, on the basis of the maximum amplitude values of the voice frame signals.

The predetermined selection conditions for selecting a voice frame signal are the same as those for selecting the phase shift amount described with reference to FIGS. 9 to 12. The predetermined selection conditions are satisfied when the gain A of a certain voice frame signal satisfies the above-mentioned conditions (1) to (3).

The voice signal selecting unit 51 selects a voice frame signal whose maximum amplitude value is the minimum from the voice frame signals satisfying the predetermined selection conditions, and outputs the selected signal to the gain determining unit 4 and the amplifying unit 5.

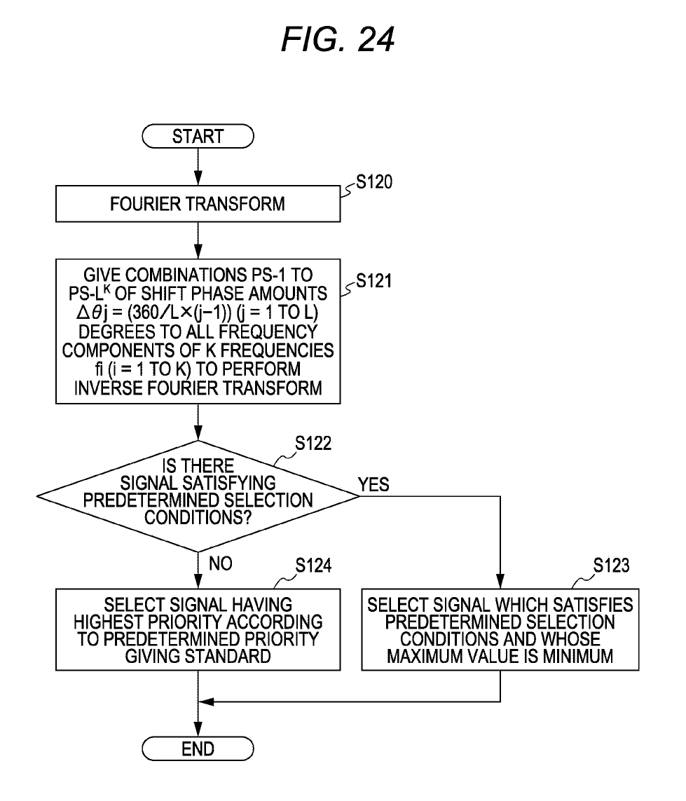

FIG. 24 is a flowchart illustrating an example of a process of reducing a maximum value of a voice signal. In Operation S120, the Fourier transformer 10 performs Fourier transform on the voice frame signals to generate frequency domain signals indicating the frequency components of K frequencies fi (i=1 to K) of the voice frame signals.

In Operation S121, the inverse Fourier transformer 50 gives each of the combinations PS-1 to PS-LK of plural kinds of phase shift amounts Δθj>(360/L×(j−1)) (j=1 to L) degrees to all the frequency components of the frequencies fi (i=1 to K) to perform inverse Fourier transform on the frequency domain signals, thereby generating the voice frame signals.

In Operation S122, the voice signal selecting unit 51 determines whether there is a voice frame signal satisfying the predetermined selection conditions among the voice frame signals generated by the inverse Fourier transformer 50. A process of determining whether the voice frame signal satisfies the predetermined selection conditions is the same as that described with reference to FIG. 12.

If it is determined in Operation S122 that there is a voice frame signal satisfying the predetermined selection conditions, the process of the voice signal selecting unit 51 proceeds to Operation S123. If it is determined that there is no voice frame signal satisfying the predetermined selection conditions, the process of the voice signal selecting unit 51 proceeds to Operation S124.

In Operation S123, the voice signal selecting unit 51 selects a voice frame signal whose maximum amplitude value is the minimum from the voice frame signals satisfying the predetermined selection conditions, and ends the process. In Operation S124, the voice signal selecting unit 51 selects a voice frame signal having the highest priority from the voice frame signals generated by the inverse Fourier transformer 50 according to a predetermined priority giving standard. For example, the priority giving standard may include the following: (1) the magnitude of the maximum amplitude value of each voice frame signal; (2) the magnitude of the distance between the range of the gain at which the amplifying unit 5 can amplify each voice frame signal without any clipping distortion and the target gain A; and (3) the magnitude of the difference between the first sample value of each voice frame signal when the amplifying unit 5 can amplify each voice frame signal without any clipping distortion and the last sample value of the previous frame.

In this embodiment, when all the combinations PS-1 to PS-LK of the phase shift amounts are given, the voice frame signals are compared. Therefore, it is possible to more appropriately select a voice frame signal.

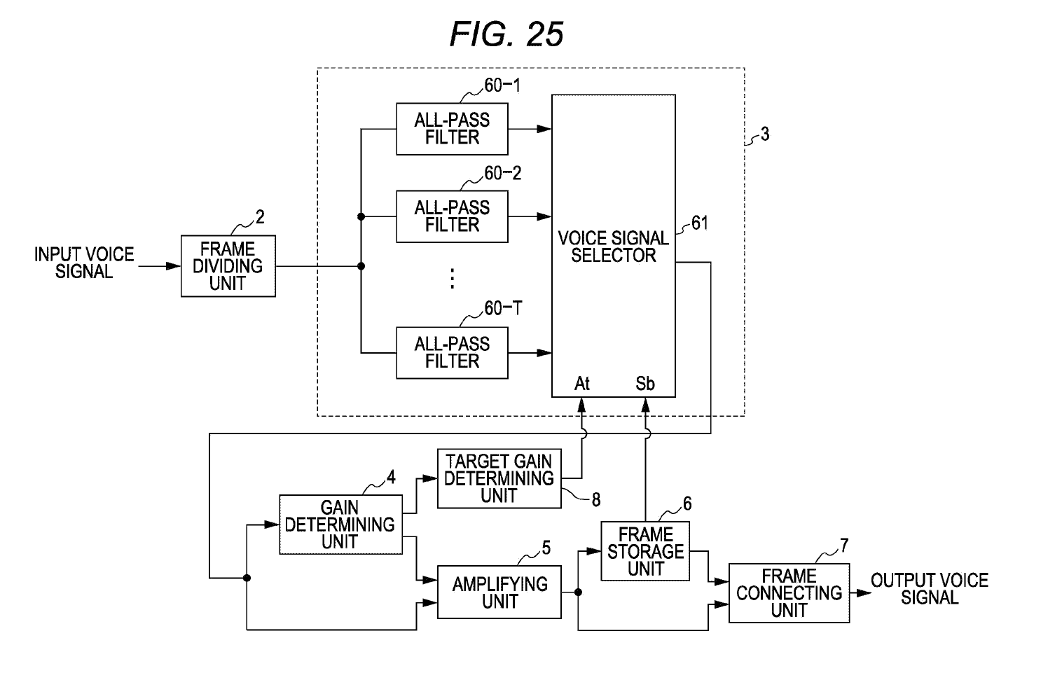

FIG. 25 is a diagram illustrating a structure of a voice processing apparatus according to an embodiment of the invention. FIG. 25 illustrates the voice processing apparatus 1 according to an embodiment of the invention. The structure of the voice processing apparatus 1 illustrated in FIG. 25 is similar to that illustrated in FIG. 23. The same components as those in FIG. 23 are denoted by the same reference numerals, and a description of the same functions as those in FIG. 23 will be omitted.

A maximum value reducing unit 3 includes a plurality of all-pass filters 60-1 to 60-T having different frequency-phase characteristics and a voice signal selecting unit 61. The voice frame signals output from the frame dividing unit 2 are filtered by the all-pass filters 60-1 to 60-T arranged in parallel to each other.

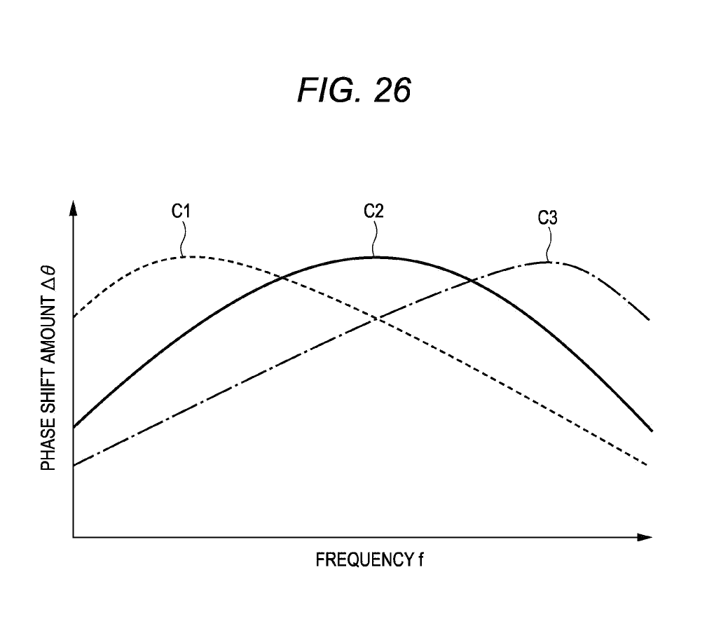

FIG. 26 is a characteristic diagram illustrating a frequency-phase characteristics of an all-pass filter. The all-pass filters 60-1 to 60-T give different phase shift amounts Δθ to the frequency components of the input signals according to the frequency components. In FIGS. 26, C1 to C3 indicate different frequency-phase characteristics, and phase shift amounts are different from each other at each frequency among the characteristics C1 to C3.

As the all-pass filters 60-1 to 60-T, filters having different frequency-phase characteristics represented by C1 to C3 are used. In this case, it is possible to generate voice signals having different waveforms, that is, different maximum amplitude values, without deteriorating the quality of a voice sensed by the user's ear. Therefore, the all-pass filters 60-1 to 60-T can be used instead of the inverse Fourier transformer 50 illustrated in FIG. 23 that gives a plurality of different amounts of phase shift to perform inverse Fourier transform.

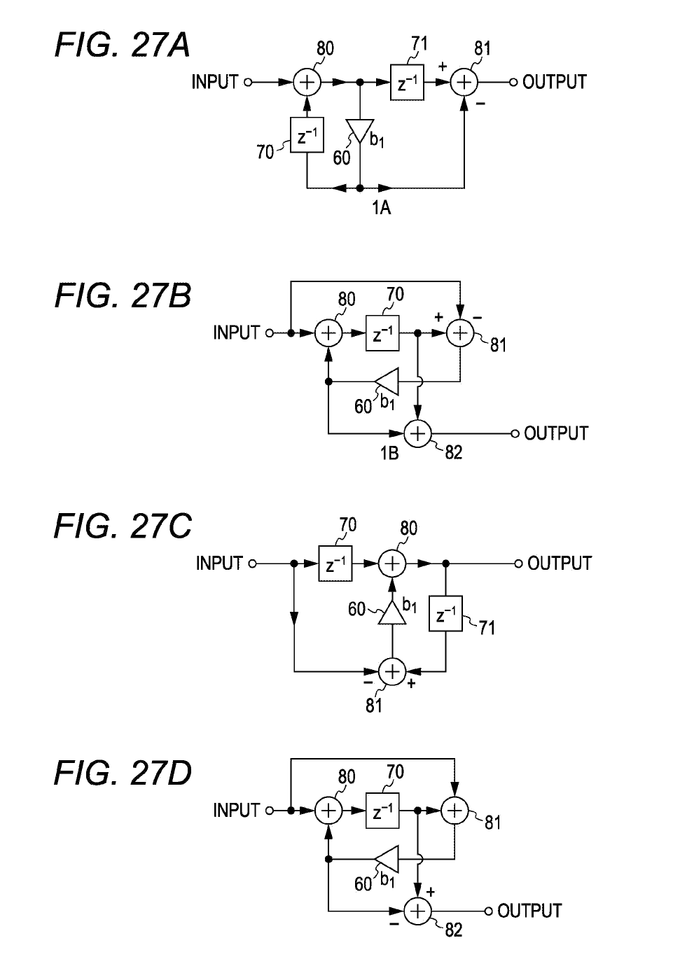

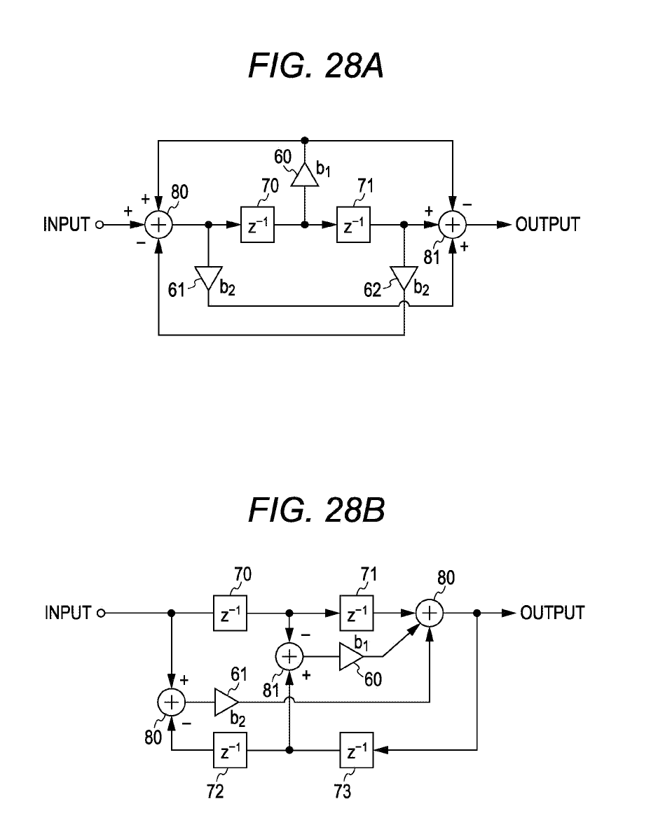

FIGS. 27A, 27B, 27C and 27D are diagrams illustrating the first to fourth structures of the all-pass filter, and FIGS. 28A and 28B are diagrams illustrating the fifth and sixth structures of the all-pass filter. In the drawings, elements 60 and 61 are amplifiers that amplify signals at gains b1 and b2, respectively, and elements 70 to 73 are delay elements that give a delay corresponding to one sample. In addition, elements 80 to 82 are adders. It is possible to achieve all-pass filters having different frequency-phase characteristics by changing the gains b1 and b2 in the all-pass filters.

The voice frame signal filtered by each of the all-pass filters 60-1 to 60-T is input to the voice signal selecting unit 61 illustrated in FIG. 25. The target gain At determined by the target gain determining unit 8 and the last sample value Sb of the previous frame stored in the frame storage unit 6 are input to the voice signal selecting unit 61. The voice signal selecting unit 61 determines whether there is a voice frame signal satisfying the above-mentioned predetermined selection conditions among the voice frame signals filtered by the all-pass filters 60-1 to 60-T on the basis of the maximum amplitude values of the voice frame signals.

The voice signal selecting unit 61 selects a voice frame signal whose maximum amplitude value is the minimum from the voice frame signals satisfying the predetermined selection conditions, and outputs the selected signal to the gain determining unit 4 and the amplifying unit 5.

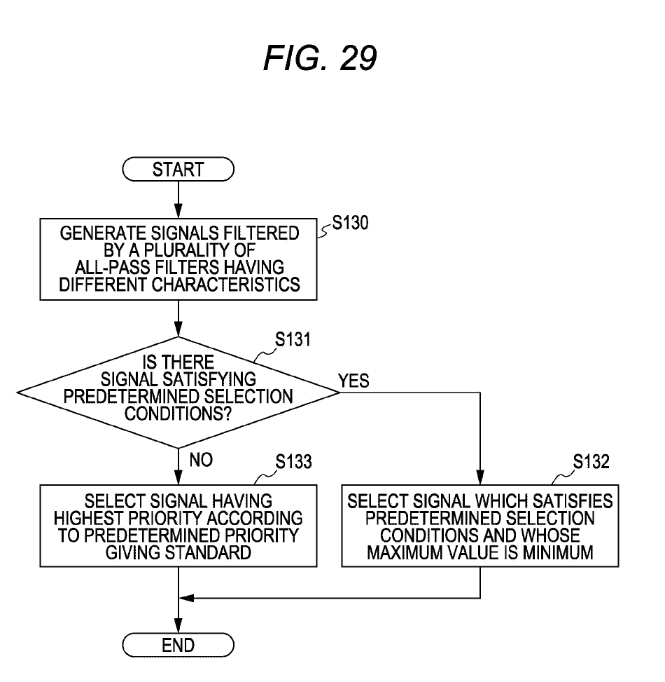

FIG. 29 is a flowchart illustrating an example of a process of reducing a maximum value of a voice signal. In Operation S130, the all-pass filters 60-1 to 60-T filter the voice frame signals output from the frame dividing unit 2.

In Operation S131, the voice signal selecting unit 61 determines whether there is a voice frame signal satisfying the predetermined selection conditions among the voice frame signals filtered by the all-pass filters 60-1 to 60-T. A process of determining the voice frame signal satisfying the predetermined selection conditions may be the same as that shown in FIG. 12.

If it is determined in Operation S131 that there is a voice frame signal satisfying the predetermined selection conditions, the process of the voice signal selecting unit 61 proceeds to Operation S132. If it is determined that there is no voice frame signal satisfying the predetermined selection conditions, the process of the voice signal selecting unit 61 proceeds to Operation S133.

In Operation S132, the voice signal selecting unit 61 selects a voice frame signal whose maximum amplitude value is the minimum from the voice frame signals satisfying the predetermined selection conditions, and ends the process. In Operation S133, the voice signal selecting unit 61 selects each voice frame signal using the same process as that in Operation S124 of FIG. 24, and ends the process.

According to this embodiment, it is possible to achieve the maximum value reducing unit 3 with a simple structure, without performing Fourier transform and inverse Fourier transform.

As described above, according to the apparatuses and methods of the above-described embodiments of the invention, the voice signal is processed such that the maximum amplitude value thereof is reduced. It is possible to increase the maximum gain at which the voice signal can be amplified in an amplifying stage without any clipping distortion. As a result, it is possible to process the input or received voice signal into a signal which the user easily hear, without deteriorating the quality of a voice sensed by the user's ear.

The embodiments can be implemented in computing hardware (computing apparatus) and/or software, such as (in a non-limiting example) any computer that can store, retrieve, process and/or output data and/or communicate with other computers. The results produced can be displayed on a display of the computing hardware. A program/software implementing the embodiments may be recorded on computer-readable media comprising computer-readable recording media. The program/software implementing the embodiments may also be transmitted over transmission communication media. Examples of the computer-readable recording media include a magnetic recording apparatus, an optical disk, a magneto-optical disk, and/or a semiconductor memory (for example, RAM, ROM, etc.). Examples of the magnetic recording apparatus include a hard disk device (HDD), a flexible disk (FD), and a magnetic tape (MT). Examples of the optical disk include a DVD (Digital Versatile Disc), a DVD-RAM, a CD-ROM (Compact Disc-Read Only Memory), and a CD-R (Recordable)/RW. An example of communication media includes a carrier-wave signal.

Further, according to an aspect of the embodiments, any combinations of the described features, functions and/or operations can be provided.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it may be understood that the various changes, substitutions, and alterations could be made hereto without departing from the spirit and scope of the invention, the scope of which is defined in the claims and their equivalents.

What is claimed is:

1. A voice signal processing apparatus, comprising:
a maximum amplitude value determining unit that determines maximum amplitude values of a plurality of different voice frame signals obtained by giving different amounts of phase shift to frequency components of voice frame signals having a predetermined length which are divided from a digital voice signal; and
a selecting unit that selects a voice frame signal having a maximum amplitude value that is a minimum among the amplitude values of the plurality of different voice frame signals.

2. The voice signal processing apparatus according to claim 1, wherein the maximum amplitude value determining unit includes:
a frequency component determining unit that determines each frequency component of the voice frame signal; and
a combination determining unit that determines a plurality of combinations of phase shift amounts given to the frequency components, and
the selecting unit selects a combination of the voice frame signals whose maximum amplitude value is a minimum among the plurality of combinations determined by the combination determining unit.

3. The voice signal processing apparatus according to claim 2,
wherein the combination determining unit includes a candidate generating unit that gives different amounts of phase shift to any one of the frequency components determined by the frequency component determining unit to generate a plurality of candidate signals, and
the selecting unit includes a candidate selecting unit that selects a shift amount given to a candidate signal whose maximum amplitude value is a minimum among the plurality of candidate signals.

4. The voice signal processing apparatus according to claim 3,
wherein the candidate generating unit generates the plurality of candidate signals and the candidate selecting unit selects the shift amount, in a descending order of spectral intensity of the plurality of frequency components, and
when generating the plurality of candidate signals for each frequency component, the candidate generating unit gives the selected shift amounts to other frequency components whose shift amounts are selected before the frequency component to generate the plurality of candidate signals.

5. The voice signal processing apparatus according to claim 3,
wherein the candidate generating unit and the candidate selecting unit generate the plurality of candidate signals and select the shift amount based on the frequency components sequentially selected from the frequency components determined by the frequency component determining unit, respectively,
the candidate generating unit gives the selected shift amounts to other frequency components whose shift amounts are selected before the frequency component to generate the plurality of candidate signals when generating the plurality of candidate signals for each frequency component, and
the candidate generating unit and the candidate selecting unit stop generation of the candidate signals and the selection of the shift amount, respectively, when the maximum amplitude value of the candidate signal generated by giving the selected shift amount to each frequency component is smaller than a predetermined threshold value.

6. The voice signal processing apparatus according to claim 3,
wherein the candidate selecting unit determines whether a predetermined amplifier can amplify each candidate signal at a gain in a predetermined allowable range based on the maximum amplitude value, and selects the shift amount from the shift amounts given to the candidate signals that are determined to be amplified.

7. The voice signal processing apparatus according to claim 3, comprising:
a frame storage unit that stores at least a last sample of a previous frame of a current voice frame signal,
wherein the candidate selecting unit includes:
a gain determining unit that determines a gain based on the maximum amplitude value of the candidate signal; and
a sample value determining unit that determines a first sample value of the candidate signal when the candidate signal is amplified at the determined gain, and
the candidate selecting unit selects the shift amount from the shift amounts given to the candidate signals in which the sample value determined by the sample value determining unit is within a predetermined allowable range from a last sample value of the previous frame.

8. The voice signal processing apparatus according to claim 2,
wherein the combination determining unit includes a candidate generating unit that gives a plurality of different amounts of phase shift to all the frequency components determined by the frequency component determining unit to generate a plurality of voice frame signals, and
the selecting unit selects a voice frame signal whose maximum amplitude value is a minimum from the plurality of voice frame signals.

9. The voice signal processing apparatus according to claim 8,
wherein the selecting unit determines whether a predetermined amplifier can amplify the voice frame signal at a gain in a predetermined allowable range based on the maximum amplitude value, and selects one of the voice frame signals that are determined to be amplified.

10. The voice signal processing apparatus according to claim 8, comprising:
a frame storage unit that stores at least a last sample of a previous frame of the current voice frame signal,
wherein the selecting unit includes:
a gain determining unit that determines a gain based on the maximum amplitude value of the voice frame signal; and
a sample value determining unit that determines a first sample value of the voice frame signal when the voice frame signal is amplified at the determined gain, and
the selecting unit selects a voice frame signal from the voice frame signals in which the sample value determined by the sample value determining unit is within a predetermined allowable range from a last sample value of the previous frame.

11. The voice signal processing apparatus according to claim 1,
wherein the maximum amplitude value determining unit includes a plurality of all-pass filters that filter the voice frame signals and have different frequency-phase characteristics, and
the selecting unit selects a voice frame signal whose maximum amplitude value is a minimum among the voice frame signals filtered by the plurality of all-pass filters.

12. The voice signal processing apparatus according to claim 1, comprising:
a signal amplifying unit that amplifies the voice frame signal at a gain corresponding to the maximum amplitude value of the voice frame signal selected by the selecting unit; and
a frame connecting unit that associates the voice frame signal amplified by the signal amplifying unit to a previous frame of a current voice frame signal,
wherein the frame connecting unit selects a target value between a first sample value of the voice frame signal and a last sample value of the previous frame, and makes a plurality of sample values from a head of the voice frame signal and a plurality of sample values from a rear end of the previous frame close to the target value.

13. A voice signal processing apparatus, comprising:
a maximum value reducing unit that gives phase shift amounts to frequency components of voice frame signals having a predetermined length which are divided from a digital voice signal to reduce maximum amplitude values of the voice frame signals; and
a signal amplifying unit that amplifies the voice frame signals having the reduced maximum amplitude values at a gain that is determined based on the reduced maximum amplitude values of the voice frame signals.

14. A voice signal processing method, comprising:
dividing a digital voice signal into voice frame signals having a predetermined length;
determining maximum amplitude values of a plurality of different voice frame signals obtained by giving different amounts of phase shift to frequency components of the divided voice frame signals; and
selecting a voice frame signal whose maximum amplitude value is a minimum among the amplitude values of the plurality of different voice frame signals.
